(19) United States
(12) Patent Application Publication
(10) Pub. No.: US 2008/0002531 A1
(43) Pub. Date: Jan. 3, 2008

(54) INFORMATION RECORDING APPARATUS, INFORMATION RECORDING METHOD, INFORMATION PROCESSING APPARATUS, AND INFORMATION PROCESSING METHOD

(76) Inventors: Akihito OGAWA, Yokohama-shi (JP); Shunsuke Kimura, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/770,289

(22) Filed: Jun. 28, 2007

(30) Foreign Application Priority Data
Jun. 30, 2006 (JP) 2006-182334

(51) Int. Cl. G11B 7/085

(52) U.S. Cl. 369/30.03; 369/100

(57) ABSTRACT

According to one embodiment, there is provided an information recording apparatus including a head unit which records data and detects a reflected light by irradiating a laser light onto a recording medium having a recorded area, an unrecorded area, and a management area, and a control unit which controls the head unit so that pattern data is recorded in the unrecorded area of the recording medium to perform finalizing process onto the recording medium, the finalizing process is interrupted in accordance with an interrupting instruction, and an interrupted position of the finalizing process is recorded in management information of the recording medium.

### CROSS-REFERENCE TO RELATED APPLICATIONS

This application is based upon and claims the benefit of priority from Japanese Patent Application No. 2006-182334, filed Jun. 30, 2006, the entire contents of which are incorporated herein by reference.

### BACKGROUND

1. Field

One embodiment of the Invention relates to an information recording apparatus, an information recording method, an information processing apparatus, and an information processing method which handle an information recording medium having a plurality of recording layers on one side thereof.

2. Description of the Related Art

Digital versatile discs (DVDs) have been popularized as recording media on which a large amount of information such as picture signals is recordable. Accordingly, it has become possible to record about a two hour-long movie onto a DVD, and watch the movie freely at home by reproducing the information by playback devices. Further, as optical disk apparatuses, there are generally playback-only devices and recording/reproducing devices. Here, because most playback-only devices are designed for read-only optical disks (for example, DVD-ROMs), it is difficult to play back recordable optical disks before recording, and recordable optical disks in recording.

Then, the processing called finalizing is utilized in order for recordable optical disks to be easily played back by playback-only devices. This is the processing in which pattern data is recorded in an unrecorded area after user data is recorded such that a recording state of a disk is made to be a format physically proximate to read-only disks to obtain a dummy area which will be an over-header area of management information or DPD tracking servo.

In some cases, however, the finalizing is extremely time-consuming. In particular, in a case of a two-layer disk, when recording of user data is terminated only onto one layer, it is necessary to fill all corresponding areas in the other layer with dummy data in some cases, and there is a possibility that it takes one or more hours for finalizing under such a condition. Additionally, process of interrupting finalizing is not given in current recording type DVD systems. When once a user start finalizing, it is impossible to operate the optical disk apparatus for one or more hours, and to turn off a power supply of a personal computer or the like connected to the optical disk apparatus, or when the power supply is forcibly turned off, data in recording is broken, or finalizing cannot be resumed in some cases.

In contrast thereto, in Jpn. Pat. Appln. KOKAI Publication No. 2004-213769, information indicating a recording state is stored in a temporary storage memory such as a flash memory of an optical disk apparatus, which makes it possible to interrupt and resume finalizing.

However, the prior art in Jpn. Pat. Appln. KOKAI Publication No. 2004-213769 has the following disadvantage. That is, there is the unavailability that, when a disk in an interrupted state is ejected, there is no compatibility with different drives and it is impossible to exchange disks during interruption. Accordingly, in a conventional optical disk device, it is impossible to perform finalizing process for another disk after finalizing process is interrupted. Further, there is the problem that it is impossible to resume finalizing process with respect to a disk on which finalizing process has been interrupted with another recorder or the like.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an explanatory diagram showing an exemplary configuration of an information recording/reproducing system according to one embodiment of the invention;

FIG. 2 is an explanatory diagram showing another exemplary configuration of the information recording/reproducing system according to one embodiment of the invention;

FIG. 3 is a block diagram showing an exemplary configuration of an optical disk apparatus according to one embodiment of the invention;

FIG. 4 is an explanatory diagram showing an exemplary configuration of a two-layer optical disk having a plurality of information recording/reproducing layers according to one embodiment of the invention;

FIG. 5 is an explanatory diagram showing an exemplary layout of respective layers of the two-layer optical disk having a plurality of information recording/reproducing layers according to one embodiment of the invention;

FIG. 6 is an explanatory diagram for explaining interlayer crosstalk of the two-layer optical disk according to one embodiment of the invention;

FIG. 7 is an explanatory diagram for explaining crosstalk of the two-layer optical disk according to one embodiment of the invention;

FIG. 8 is an explanatory diagram for explaining clearances (recording-inhibited area) in the optical disk according to one embodiment of the invention;

FIG. 9 is an explanatory diagram showing an exemplary detailed layout in a recordable area in the two-layer optical disk according to one embodiment of the invention;

FIG. 10 is an explanatory diagram showing contents of format information in a system lead-in or system lead-out area provided to layer 0 of the two-layer optical disk according to one embodiment of the invention;

FIG. 11 is an explanatory diagram showing detailed contents of a data area structure in the two-layer optical disk according to one embodiment of the invention;

FIG. 12 is an explanatory diagram showing detailed contents of format information in a recordable management zone of the two-layer optical disk according to one embodiment of the invention;

FIG. 13 is an explanatory diagram showing contents of a data area structure in the format information in the recordable management zone of the two-layer optical disk according to one embodiment of the invention;

FIG. 14 is an explanatory diagram showing detailed contents of starting physical sector numbers in border zones in the format information in the recordable management zone of the two-layer optical disk according to one embodiment of the invention;

FIG. 15 is an explanatory diagram showing exemplary configurations of a recording management data copy zone and a recording management zone of the two-layer optical disk according to one embodiment of the invention;

FIG. 16 is an explanatory diagram showing detailed contents in the management zone of the two-layer optical disk according to one embodiment of the invention;

FIG. 17 is an explanatory diagram showing an exemplary configuration of recording management data of the two-layer optical disk according to one embodiment of the invention;

FIG. 18 is an explanatory diagram showing one example of contents in Field 0 of the recording management data of the two-layer optical disk according to one embodiment of the invention;

FIG. 19 is an explanatory diagram showing one example of details of a data area structure in the recording management data of the two-layer optical disk according to one embodiment of the invention;

FIG. 20 is an explanatory diagram showing one example of contents of an updated data area structure of the two-layer optical disk according to one embodiment of the invention;

FIG. 21 is an explanatory diagram showing one example of contents of padding state information of the two-layer optical disk according to one embodiment of the invention;

FIG. 22 is an explanatory diagram showing one example of contents in Field 3 of the recording management data of the two-layer optical disk according to one embodiment of the invention;

FIG. 23 is an explanatory diagram showing one example of contents in Fields 4, 5, 6, . . . , and 21 of the recording management data of the two-layer optical disk according to one embodiment of the invention;

FIG. 24 is an explanatory diagram showing exemplary commands possessed by the optical disk apparatus (disk drive apparatus) according to one embodiment of the present invention;

FIGS. 25A and 25B are explanatory diagrams showing exemplary bit configurations of signals of instructing to interrupt and resume finalizing which are given to the optical disk apparatus (disk drive apparatus) according to one embodiment of the invention;

FIGS. 26A to 26C are explanatory diagrams showing exemplary bit configurations of disk state confirming instruction signals to be given to the optical disk apparatus (disk drive apparatus) according to one embodiment of the invention;

FIGS. 27A and 27B are explanatory diagrams showing exemplary bit configurations of reply data from the optical disk apparatus according to instructions given to the optical disk apparatus (disk drive apparatus) according to one embodiment of the invention;

FIGS. 28A and 28B are explanatory diagrams showing exemplary bit configurations of data of an interrupting function confirming instruction from a host according to one embodiment of the invention;

FIGS. 29A and 29B are explanatory diagrams showing exemplary bit configurations of an interrupted state confirming instruction from the host according to one embodiment of the invention;

FIG. 30 is an explanatory diagram showing an exemplary state transition diagram of an optical disk due to finalizing process by the optical disk apparatus (disk drive apparatus) according to one embodiment of the invention;

FIGS. 31A to 31C are explanatory diagrams showing one example of recording states of respective areas in the optical disk from an empty state to a finalized state by the optical disk apparatus (disk drive apparatus) according to one embodiment of the invention;

FIG. 32 is an explanatory diagram showing one example of recording states of the respective areas in the optical disk when finalizing process by the optical disk apparatus (disk drive apparatus) is interrupted;

FIGS. 33A and 33B are explanatory diagram showing another example of recording states of the respective areas in the optical disk (interruption at a good breakpoint) when finalizing process by the optical disk apparatus (disk drive apparatus) is interrupted;

FIGS. 34A and 34B are explanatory diagrams showing another example of recording states of the respective areas in the optical disk (in a case where interruption is stopped because of a halfway position) when finalizing process by the optical disk apparatus (disk drive apparatus) is interrupted;

FIG. 35 is a flowchart showing an exemplary basic operation of finalizing process by the optical disk apparatus (disk drive apparatus);

FIG. 36 is a flowchart showing another exemplary operation when finalizing is interrupted after determining a recording amount or the like of finalizing process by the optical disk apparatus (disk drive apparatus);

FIG. 37 is a flowchart showing another exemplary operation when finalizing is interrupted after determining a recording amount or the like of finalizing process by the optical disk apparatus (disk drive apparatus);

FIG. 38 is a flowchart showing an exemplary operation of resuming finalizing when a disk is inserted into the optical disk apparatus (disk drive apparatus);

FIGS. 39A to 39C are explanatory diagrams showing exemplary GUIs to be displayed for finalizing process by the optical disk apparatus (disk drive apparatus);

FIG. 40 is a flowchart when displaying a screen for urging to resume finalizing before a disk in the optical disk apparatus (disk drive apparatus) is ejected;

FIGS. 41A and 41B are explanatory diagrams for explaining exemplary screens for urging to resume finalizing before a disk in the optical disk apparatus (disk drive apparatus) is ejected;

FIGS. 42A to 42D are explanatory diagrams showing exemplary recording states of the respective areas in the optical disk when finalizing process by the optical disk apparatus (disk drive apparatus) is interrupted;

FIGS. 43A to 43D are explanatory diagrams showing exemplary recording states of the respective areas in the optical disk when finalizing process by the optical disk apparatus (disk drive apparatus) is interrupted;

FIGS. 44A to 44C are explanatory diagrams showing exemplary recording states of the respective areas in the optical disk when finalizing process by the optical disk apparatus (disk drive apparatus) is interrupted; and

FIGS. 45A to 45D are explanatory diagrams showing exemplary recording states of the respective areas in the optical disk when finalizing process by the optical disk apparatus (disk drive apparatus) is interrupted.

### DETAILED DESCRIPTION

Various embodiments according to the invention will be described hereinafter with reference to the accompanying drawings. In general, according to one embodiment of the invention, an information recording apparatus comprising: a head unit which records data and detects a reflected light by irradiating a laser light onto a recording medium having a recorded area, an unrecorded area, and a management area; and a control unit which controls the head unit so that pattern data is recorded in the unrecorded area of the recording medium to perform finalizing process onto the recording medium, the finalizing process is interrupted in accordance with an interrupting instruction, and an interrupted position of the finalizing process is recorded in management information of the recording medium.

One embodiment of the present invention provides an information processing apparatus and an information processing method capable of performing interruption and resumption of finalizing process arbitrarily.

One embodiment of the present invention is an information recording apparatus including: a head unit (21) which records data and detects a reflected light by irradiating a laser light onto a recording medium (10) having a recorded area (R), an unrecorded area (T, m), and a management area (RMD); and a control unit (29) which controls the head unit so that pattern data is recorded onto the unrecorded area of the recording medium to perform finalizing process onto the recording medium, the finalizing process is interrupted in accordance with an interrupting instruction, and an interrupted position of the finalizing process is recorded into management information of the recording medium.

Accordingly, it is possible to arbitrarily interrupt and resume relatively time-consuming finalizing process. Further, because interruption information is stored in a disk, it is possible to complete the remaining finalizing process onto the disk on which finalizing process has been once interrupted with another recorder.

Hereinafter, embodiments of an information recording medium, an information recording apparatus, and an information recording method according to the present invention will be described with reference to the drawings.

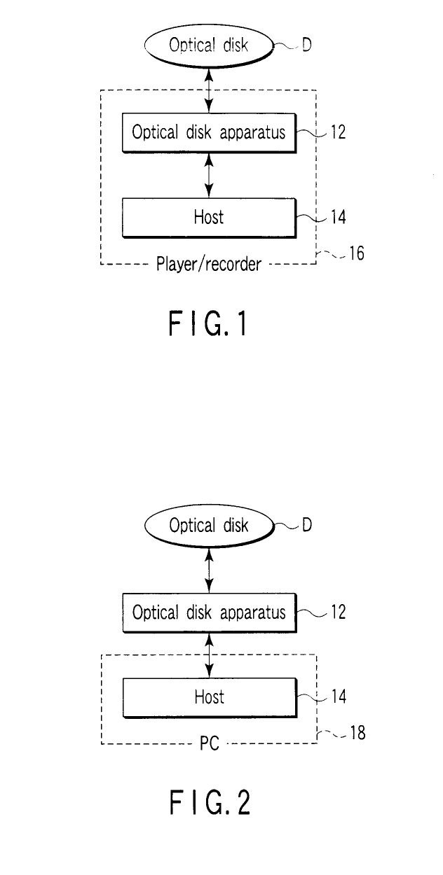

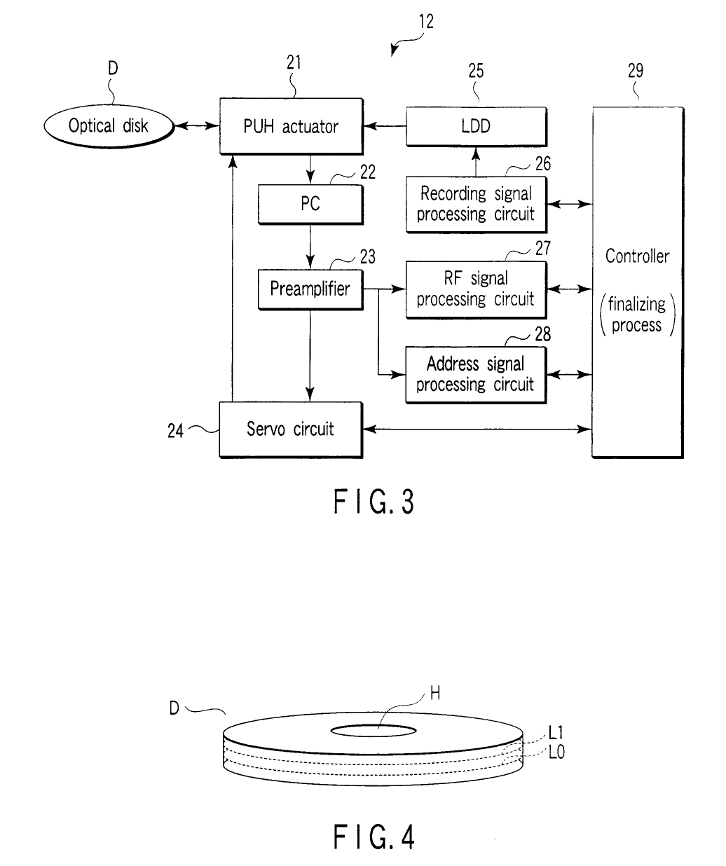

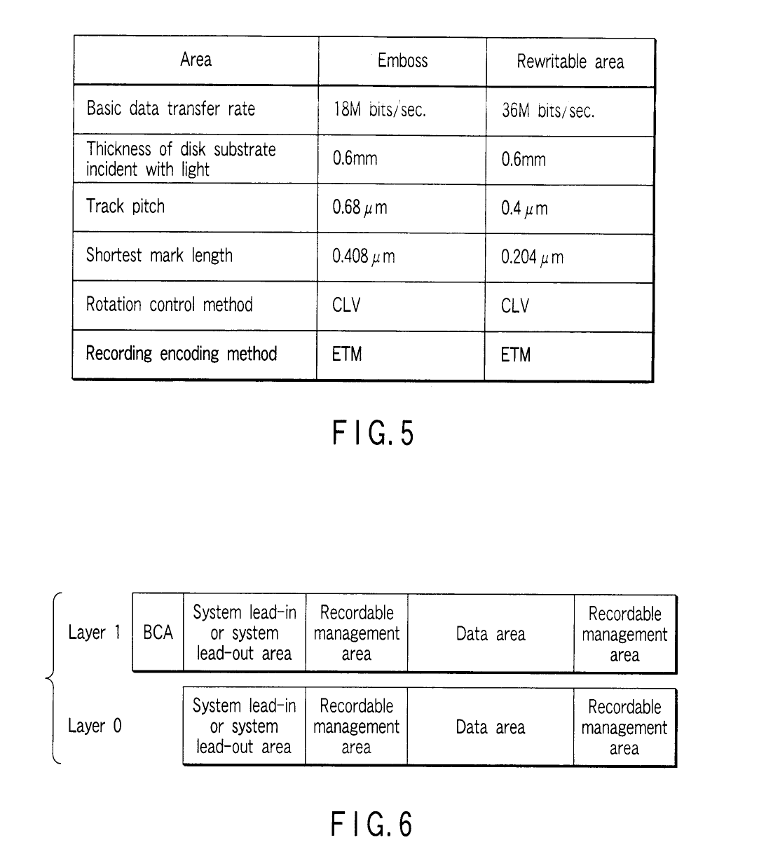

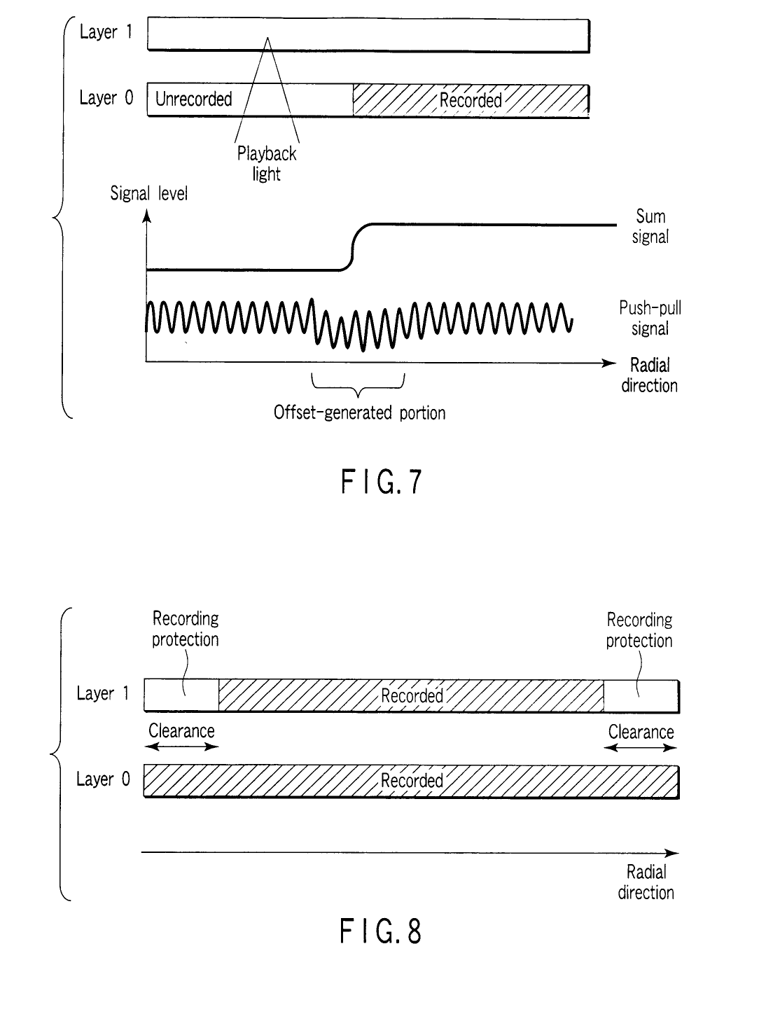

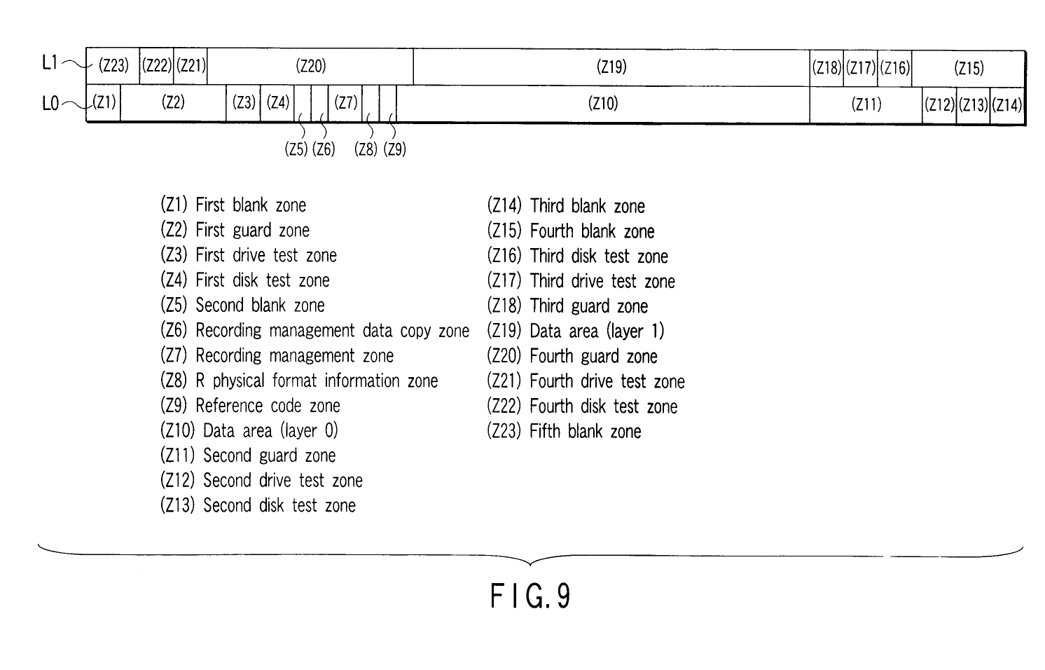

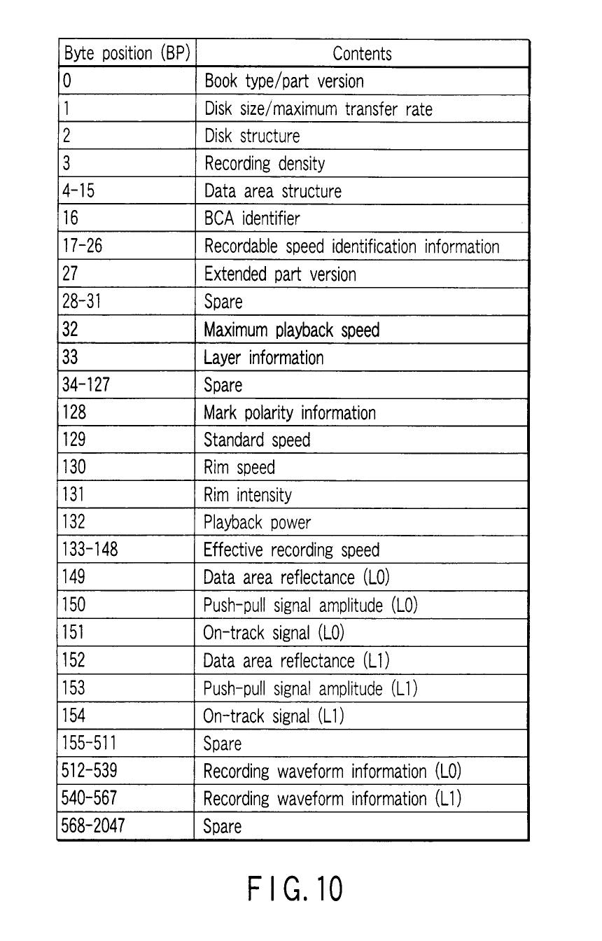

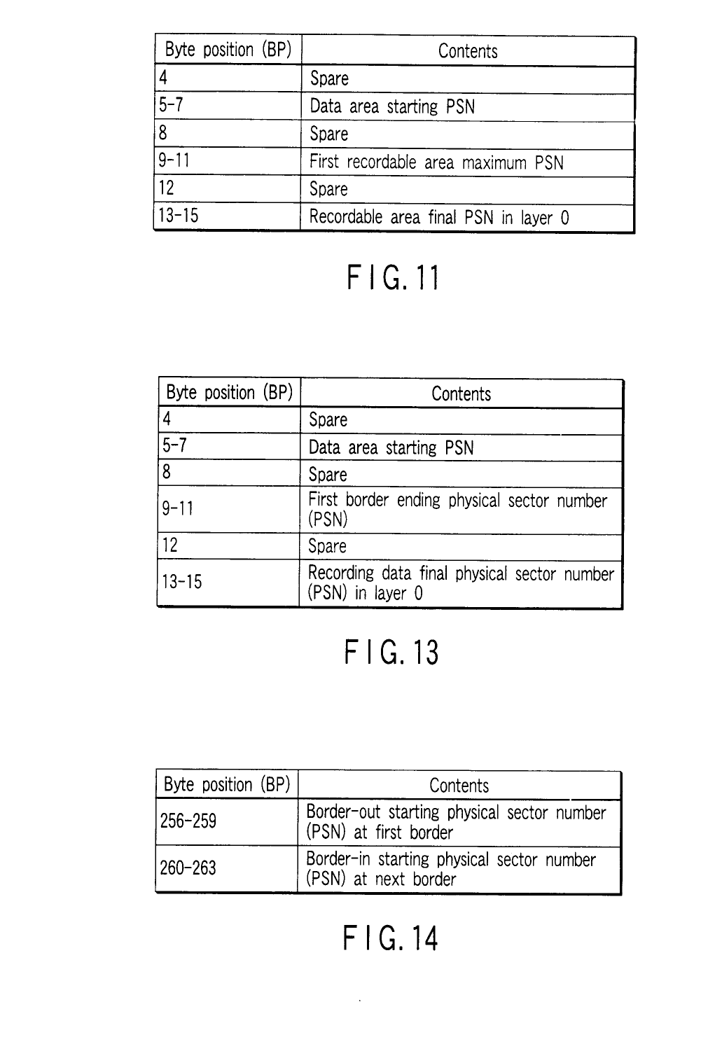

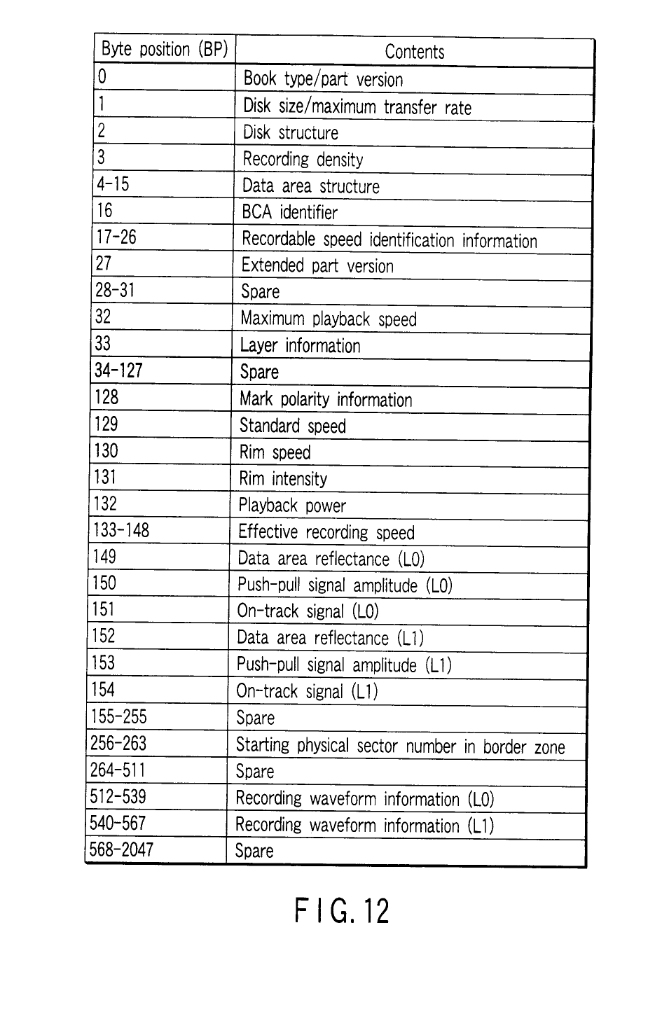

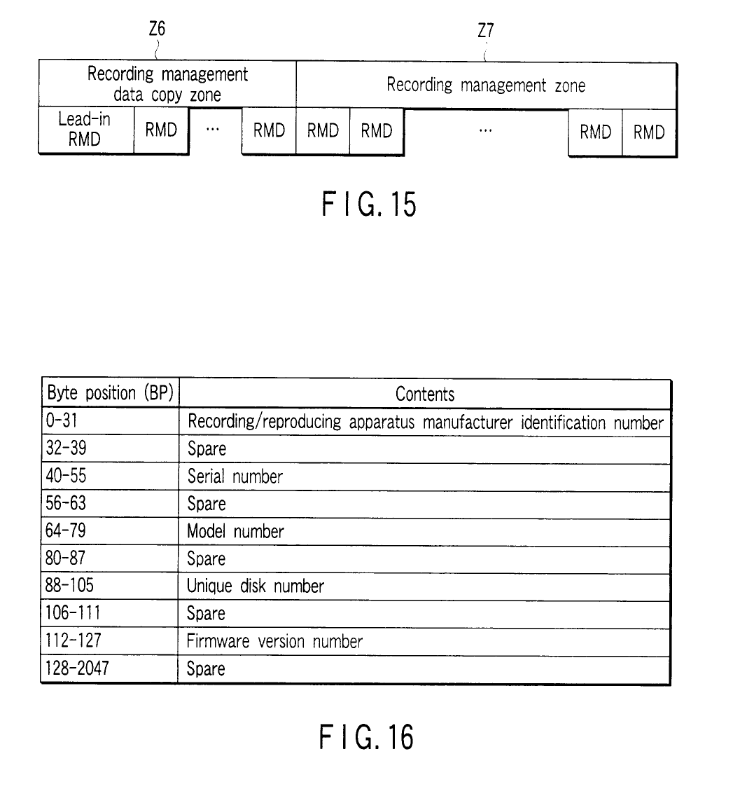

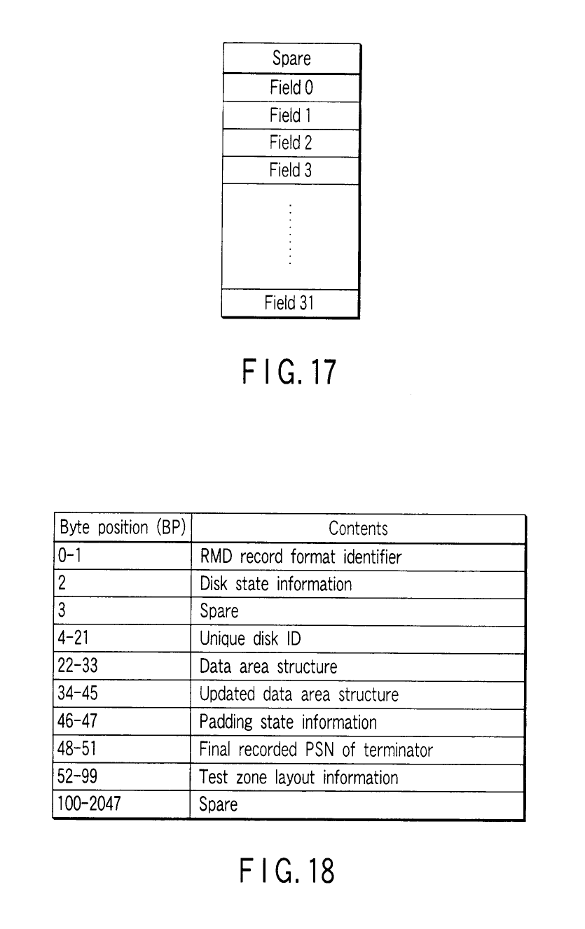

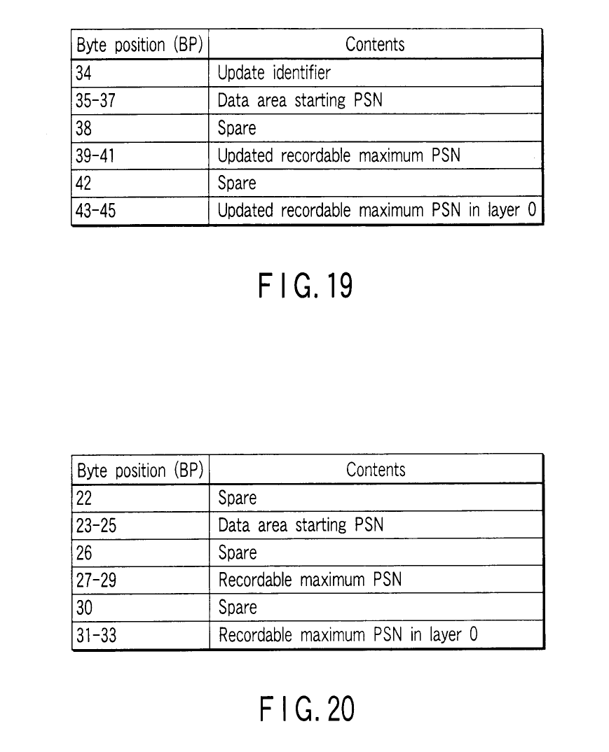

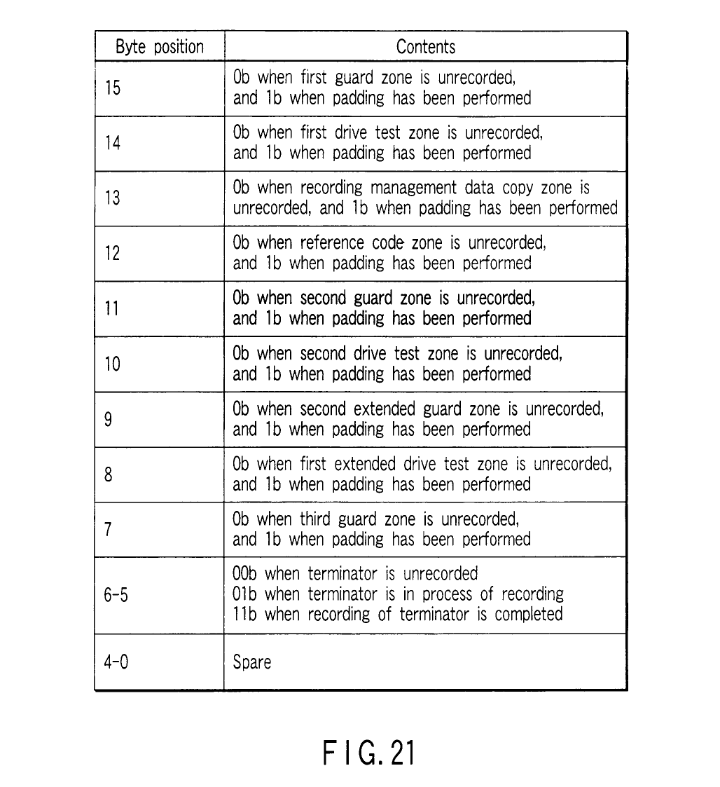

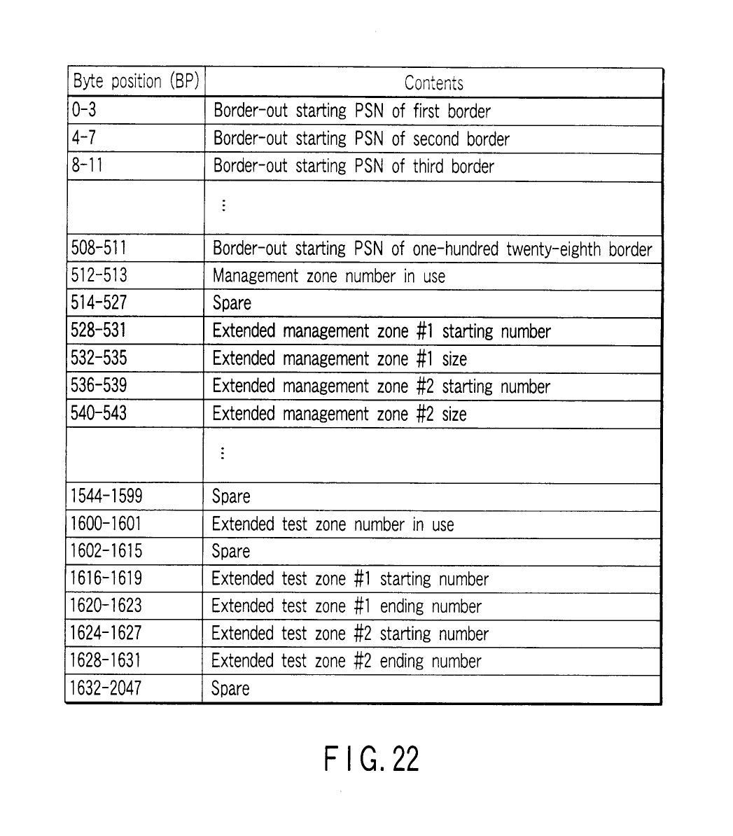

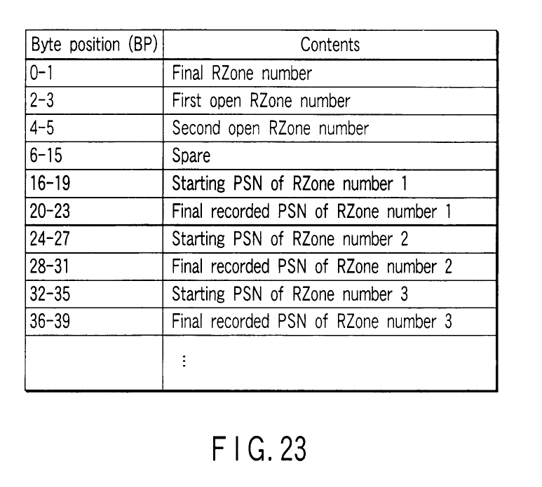

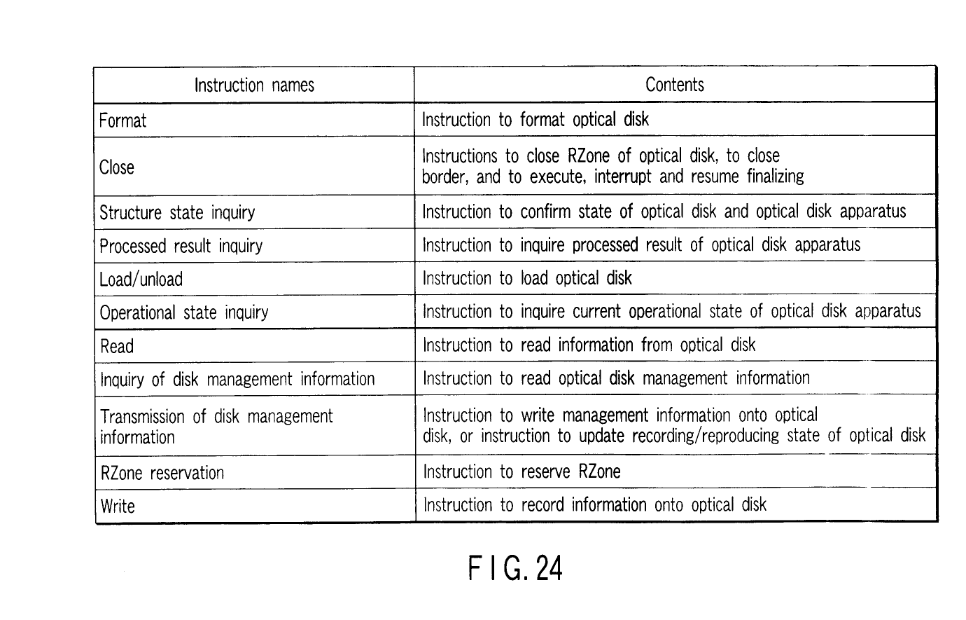

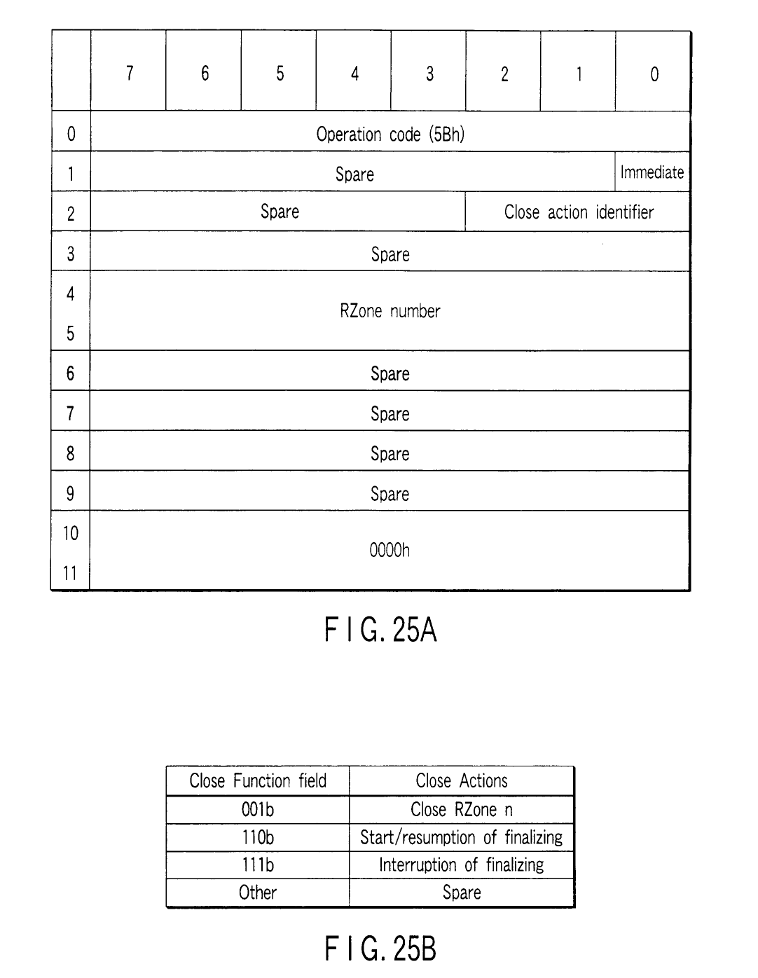

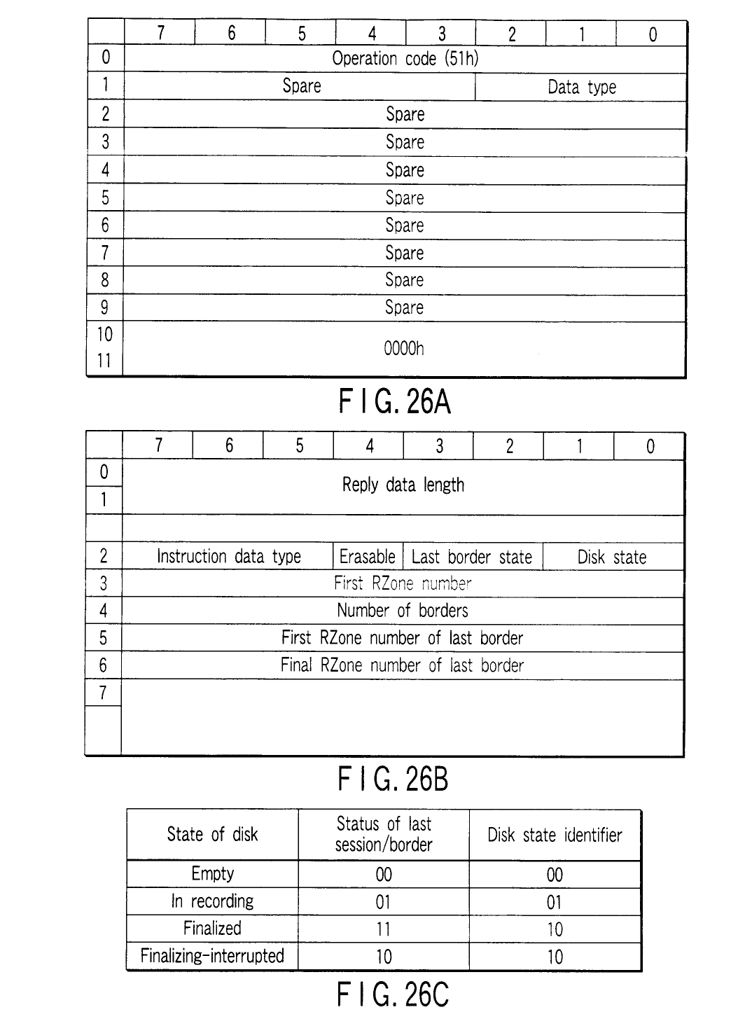

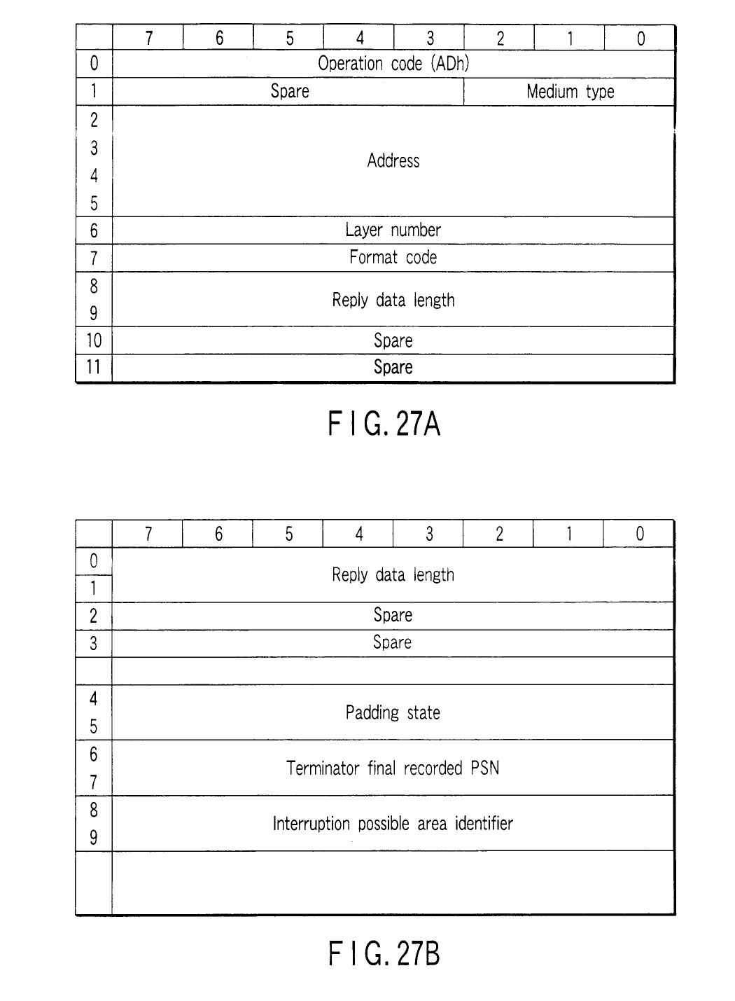

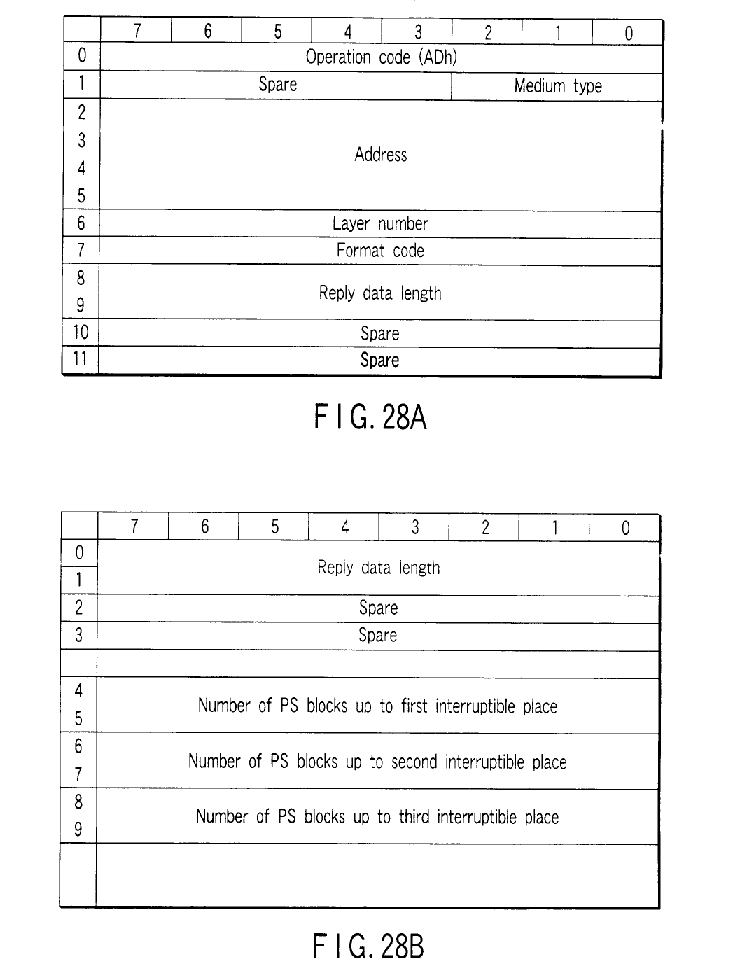

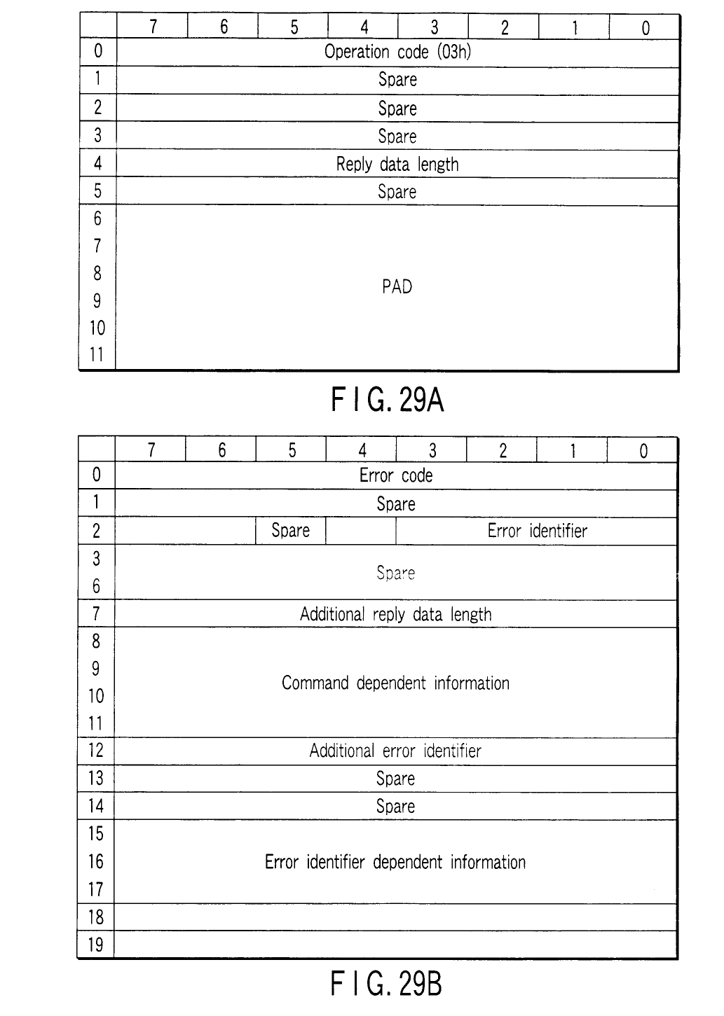

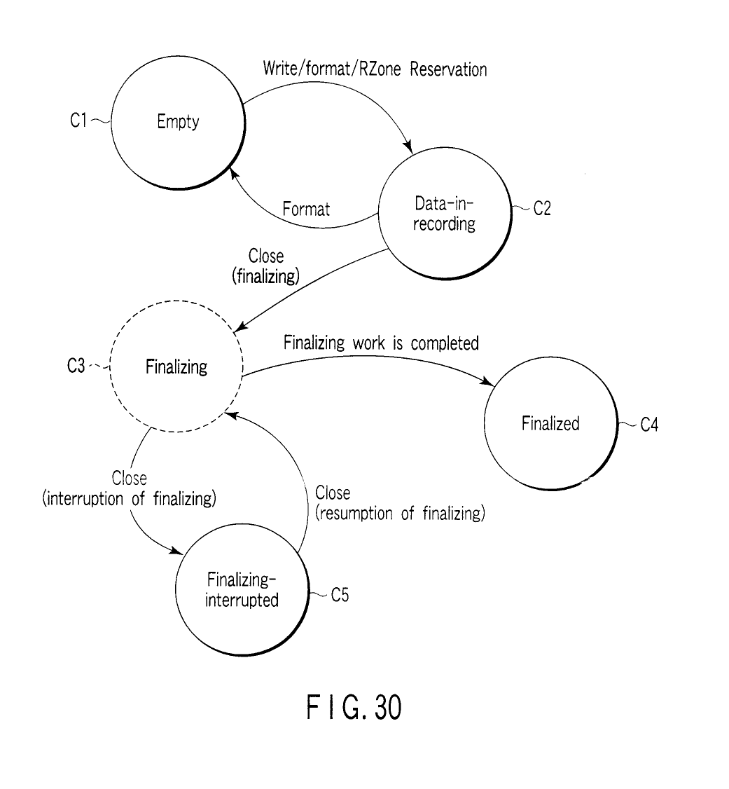

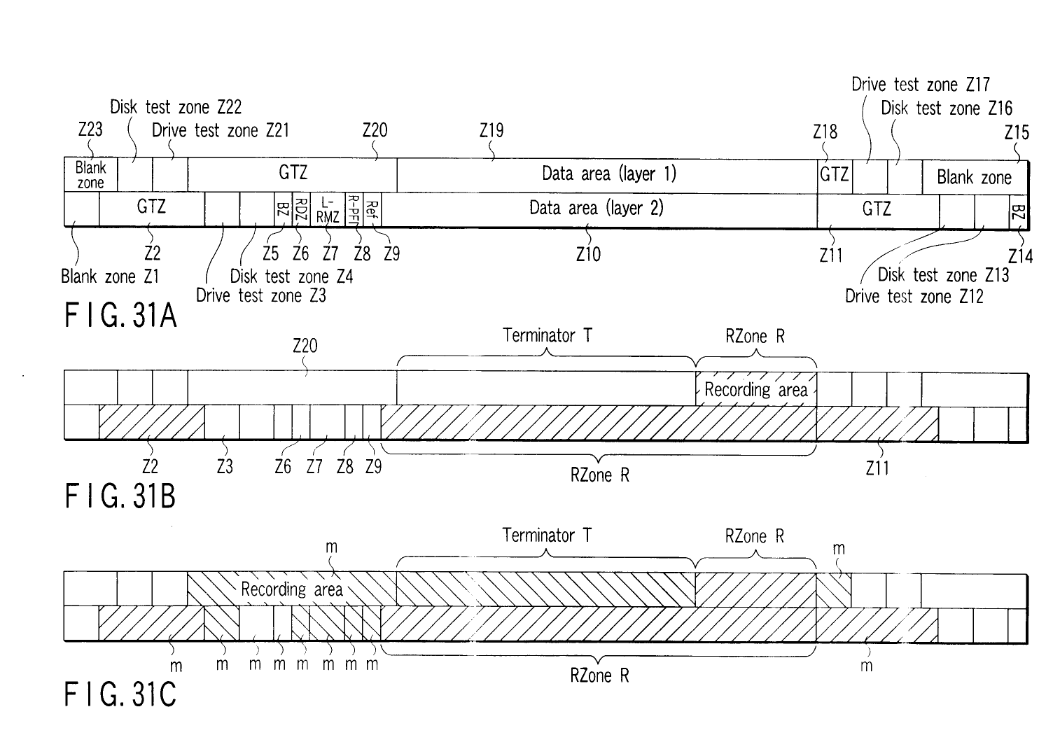

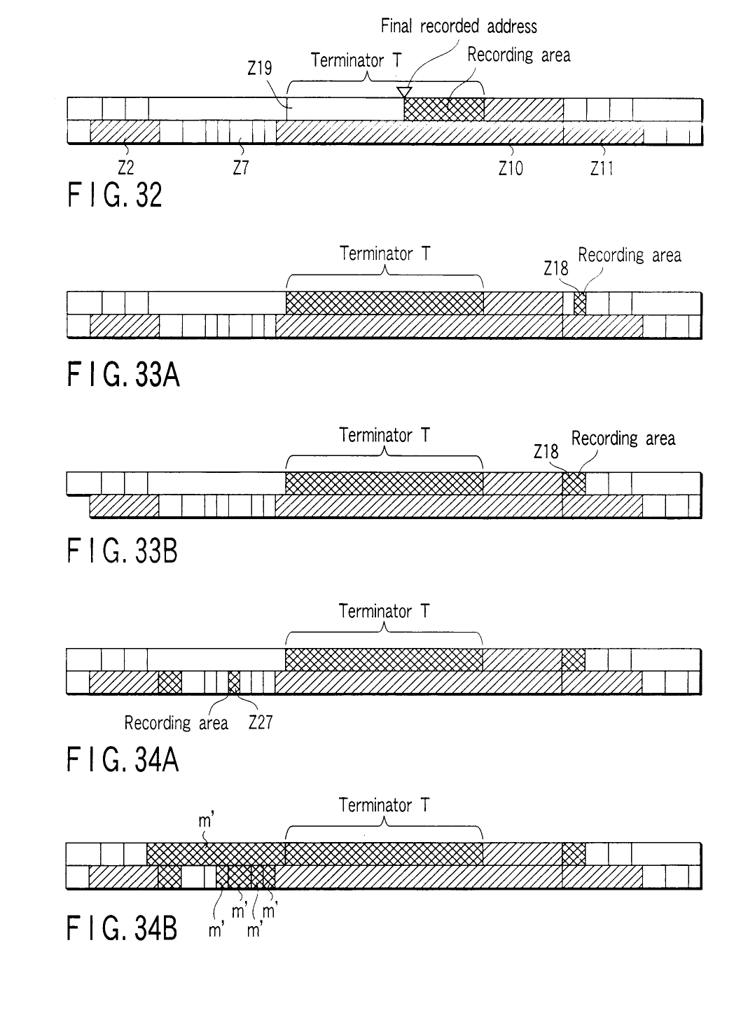

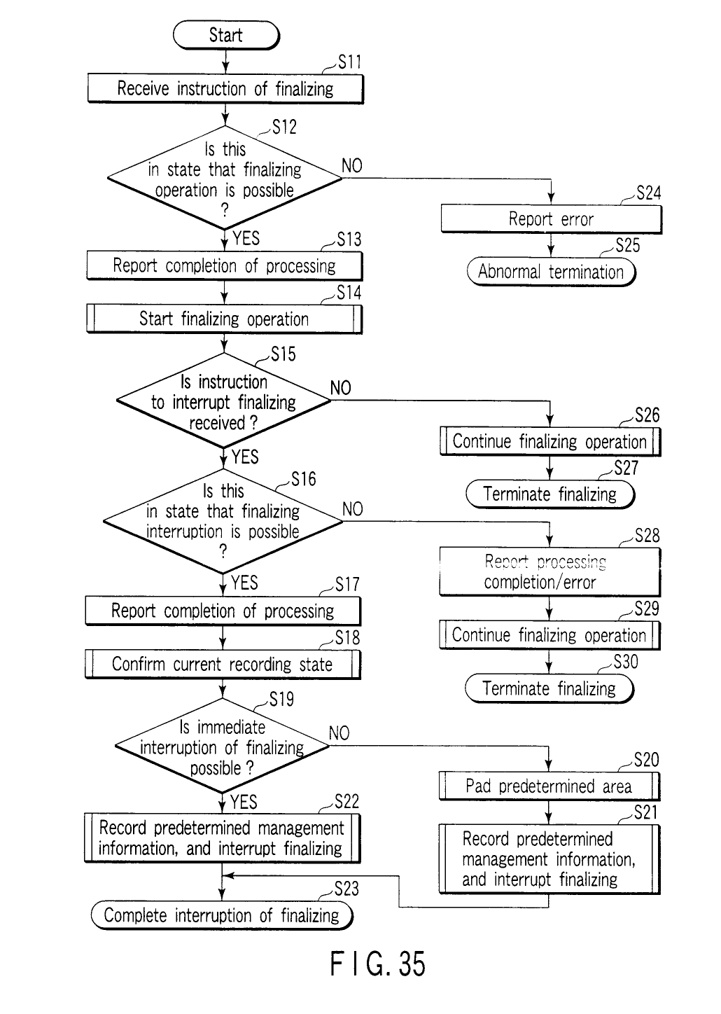

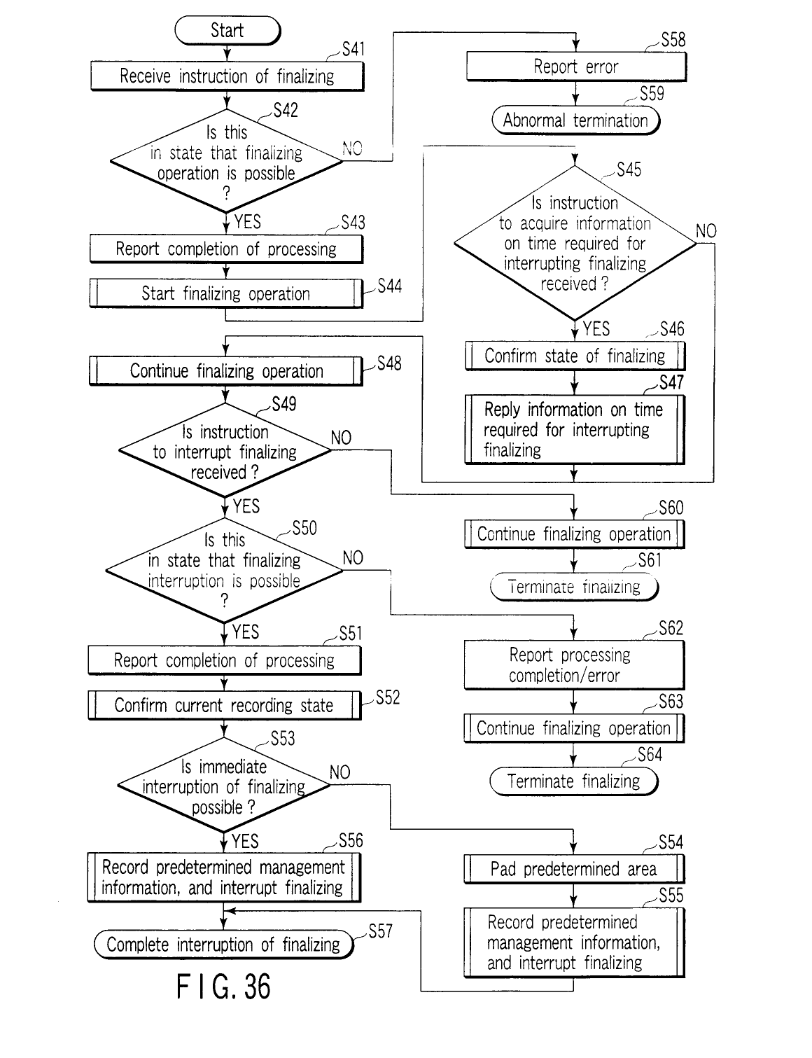

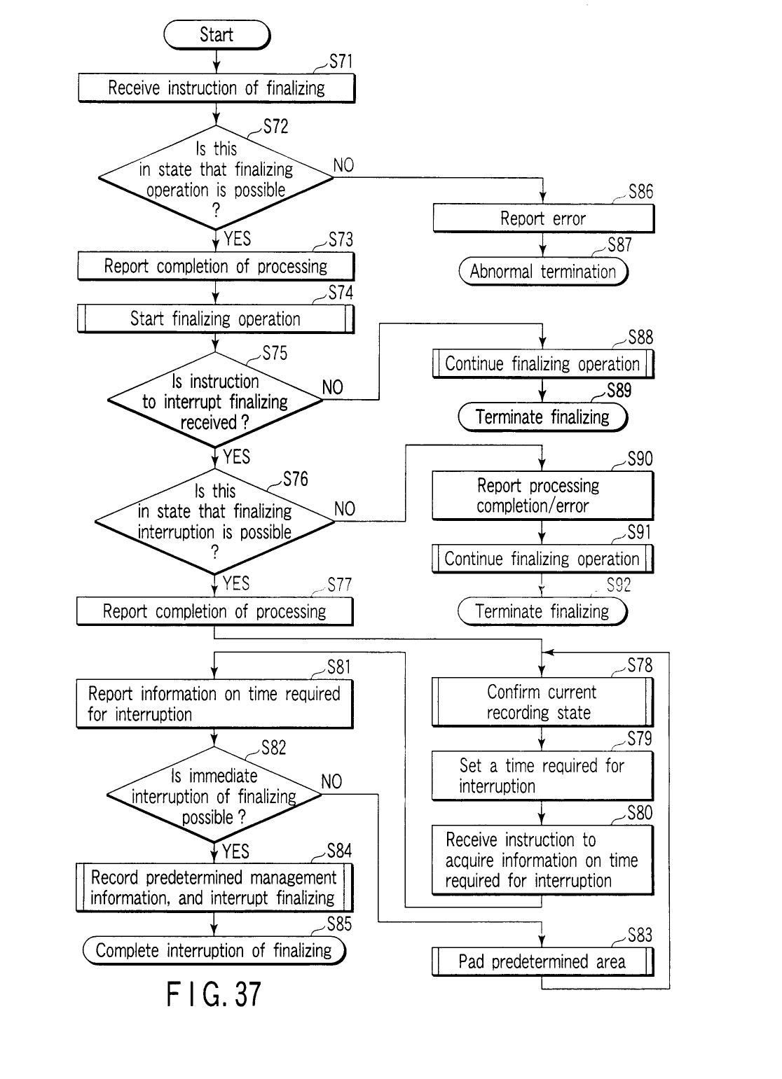

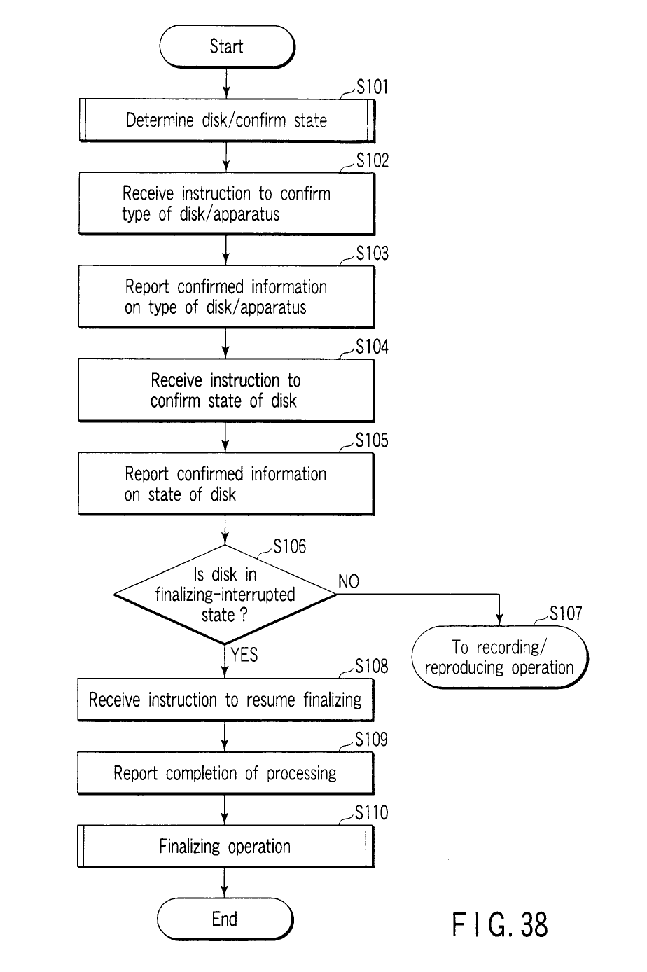

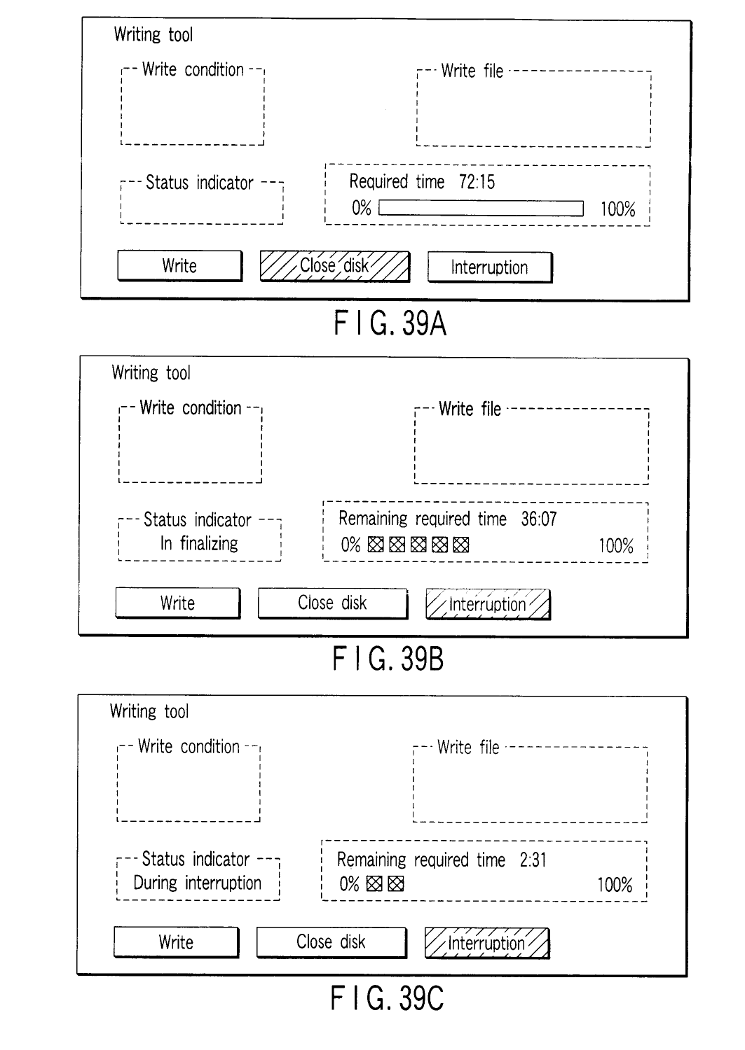

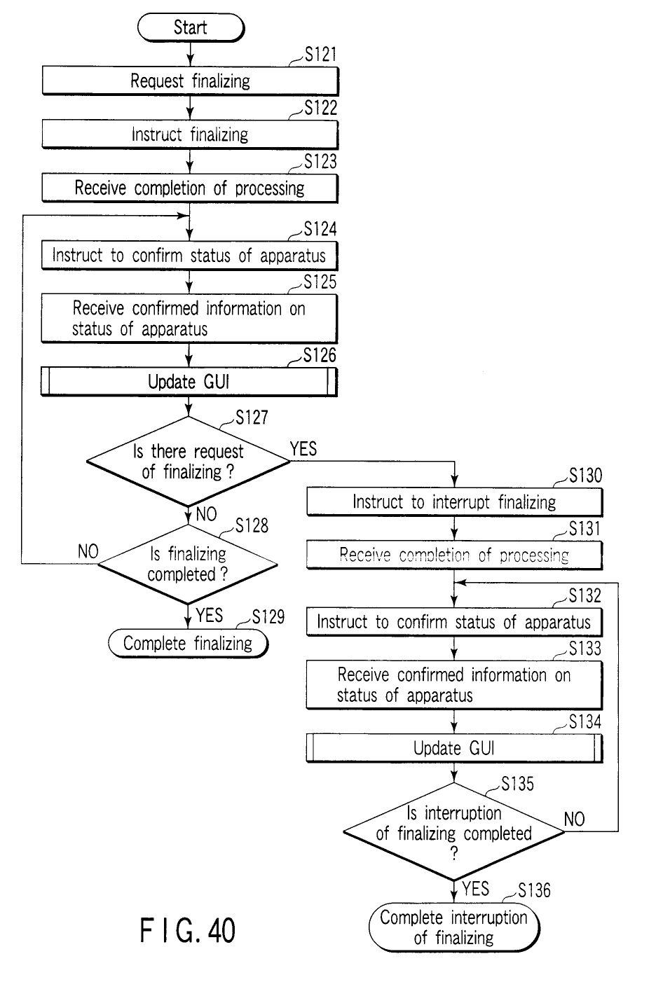

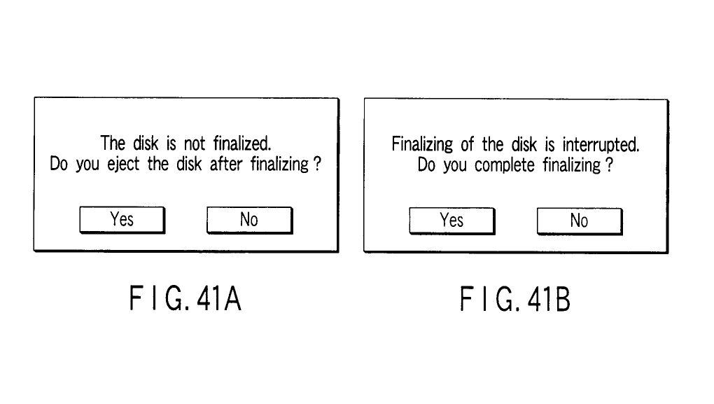

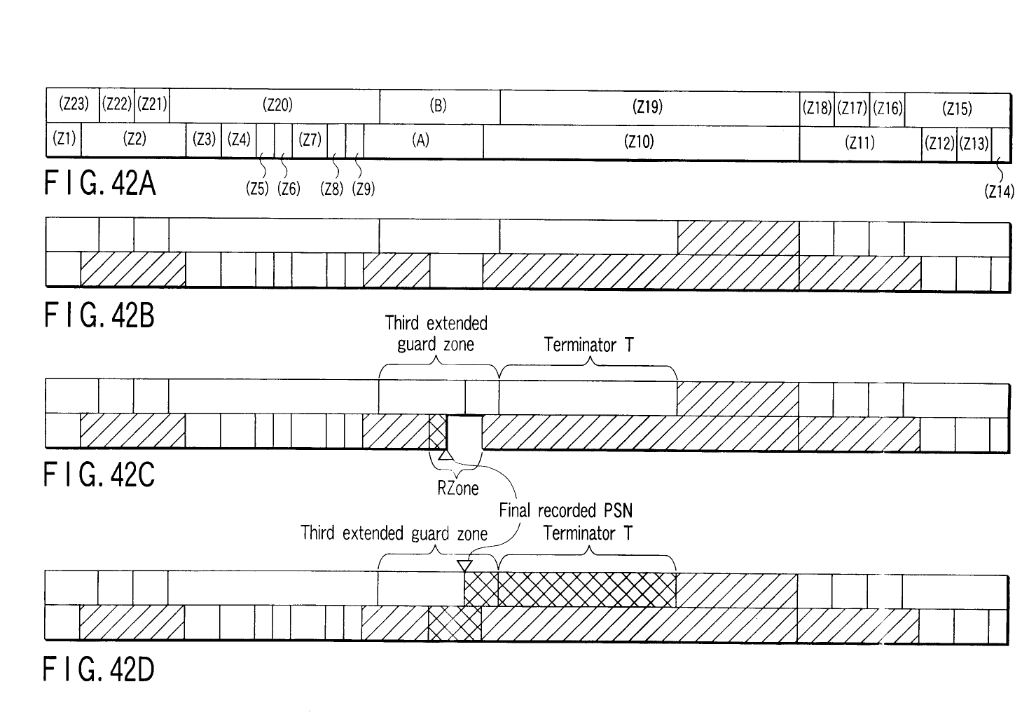

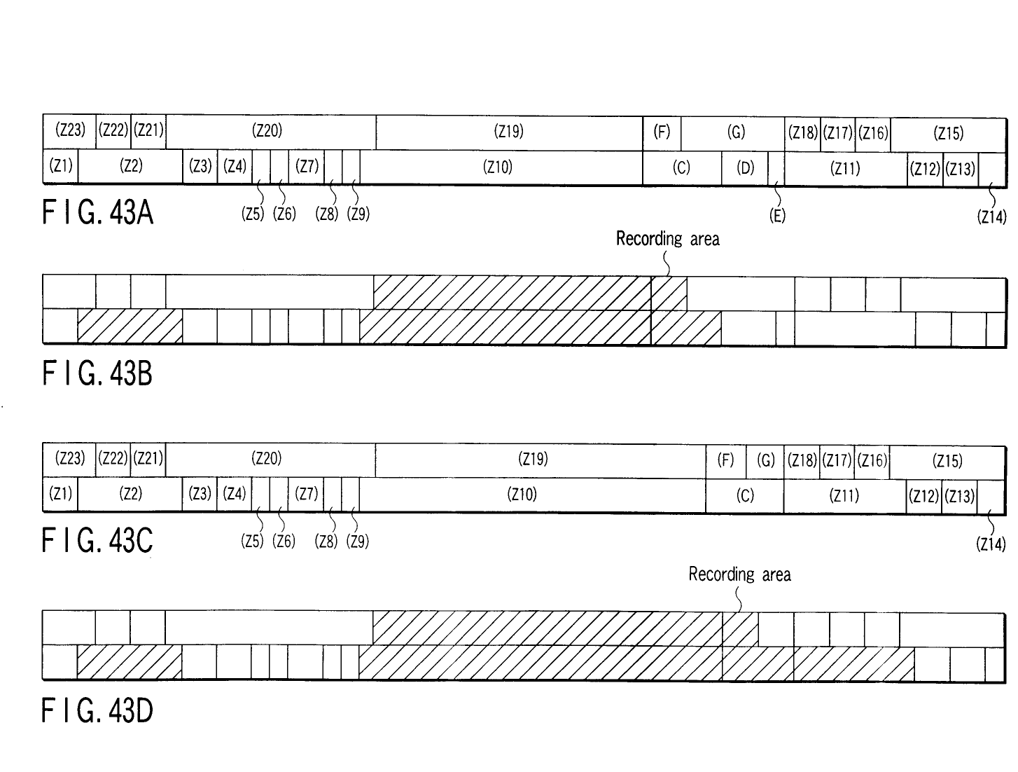

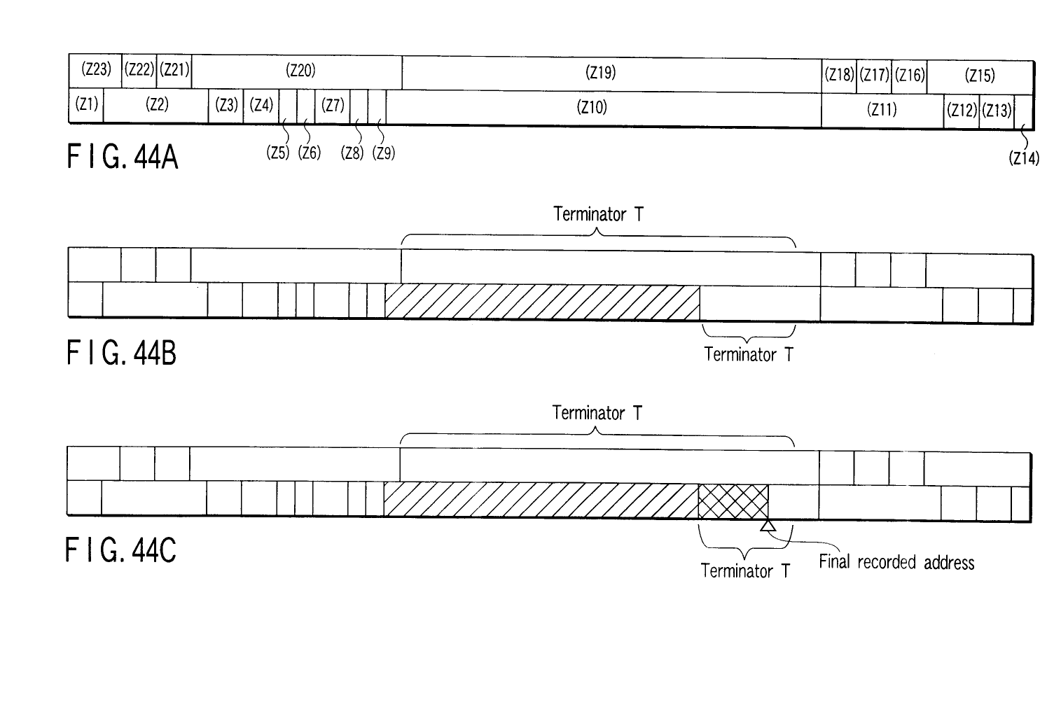

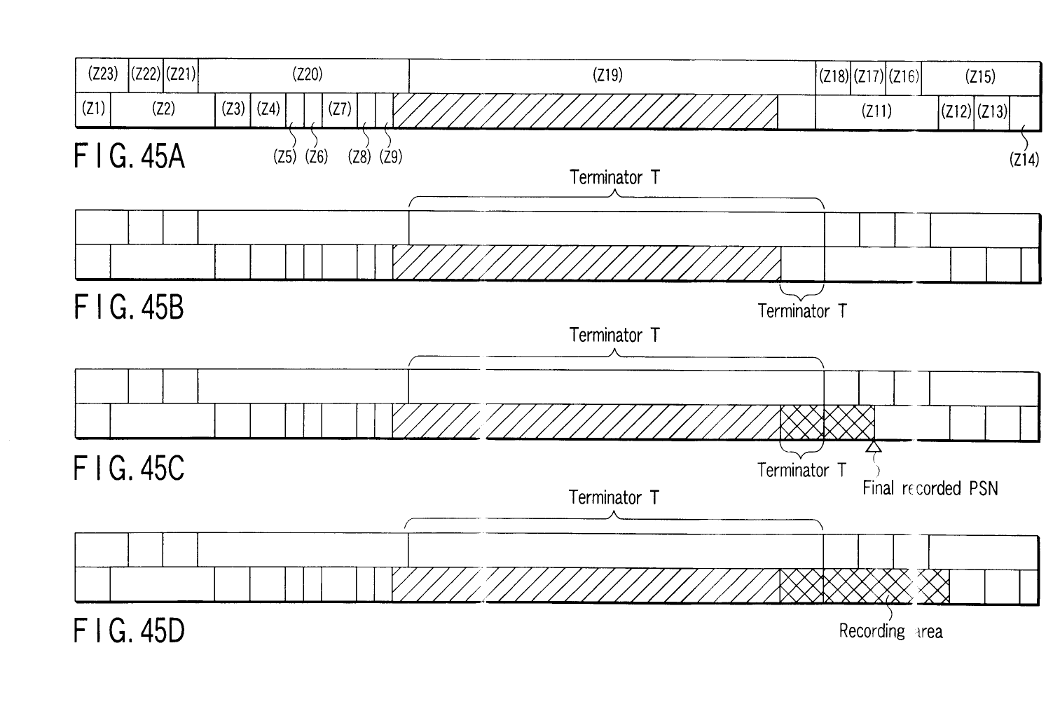

FIG. 1 is an explanatory diagram showing an exemplary configuration of an information recording/reproducing system according to one embodiment of the invention. FIG. 2 is an explanatory diagram showing another exemplary configuration of the information recording/reproducing system according to one embodiment of the invention. FIG. 3 is a block diagram showing an exemplary configuration of an optical disk apparatus according to one embodiment of the invention. FIG. 4 is an explanatory diagram showing an exemplary configuration of a two-layer optical disk having a plurality of information recording/reproducing layers according to one embodiment of the invention. FIG. 5 is an explanatory diagram showing an exemplary layout of respective layers of the two-layer optical disk having a plurality of information recording/reproducing layers according to one embodiment of the invention. FIG. 6 is an explanatory diagram for explaining interlayer crosstalk of the two-layer optical disk according to one embodiment of the invention. FIG. 7 is an explanatory diagram for explaining crosstalk of the two-layer optical disk according to one embodiment of the invention. FIG. 8 is an explanatory diagram for explaining clearances (recording-inhibited area) in the optical disk according to one embodiment of the invention. FIG. 9 is an explanatory diagram showing an exemplary detailed layout in a recordable area in the two-layer optical disk according to one embodiment of the invention. FIG. 10 is an explanatory diagram showing contents of format information in a system lead-in or system lead-out area provided to layer 0 of the two-layer optical disk according to one embodiment of the invention. FIG. 11 is an explanatory diagram showing detailed contents of a data area structure in the two-layer optical disk according to one embodiment of the invention. FIG. 12 is an explanatory diagram showing detailed contents of format information in a recordable management zone of the two-layer optical disk according to one embodiment of the invention. FIG. 13 is an explanatory diagram showing contents of a data area structure in the format information in the recordable management zone of the two-layer optical disk according to one embodiment of the invention. FIG. 14 is an explanatory diagram showing detailed contents of starting physical sector numbers in border zones in the format information in the recordable management zone of the two-layer optical disk according to one embodiment of the invention. FIG. 15 is an explanatory diagram showing exemplary configurations of a recording management data copy zone and a recording management zone of the two-layer optical disk according to one embodiment of the invention. FIG. 16 is an explanatory diagram showing detailed contents in the management zone of the two-layer optical disk according to one embodiment of the invention. FIG. 17 is an explanatory diagram showing an exemplary configuration of recording management data of the two-layer optical disk according to one embodiment of the invention. FIG. 18 is an explanatory diagram showing one example of contents in Field 0 of the recording management data of the two-layer optical disk according to one embodiment of the invention. FIG. 19 is an explanatory diagram showing one example of details of a data area structure in the recording management data of the two-layer optical disk according to one embodiment of the invention. FIG. 20 is an explanatory diagram showing one example of contents of an updated data area structure of the two-layer optical disk according to one embodiment of the invention. FIG. 21 is an explanatory diagram showing one example of contents of padding state information of the two-layer optical disk according to one embodiment of the invention. FIG. 22 is an explanatory diagram showing one example of contents in Field 3 of the recording management data of the two-layer optical disk according to one embodiment of the invention. FIG. 23 is an explanatory diagram showing one example of contents in Fields 4, 5, 6, . . . , and 21 of the recording management data of the two-layer optical disk according to one embodiment of the invention. FIG. 24 is an explanatory diagram showing exemplary commands possessed by the optical disk apparatus (disk drive apparatus) according to one embodiment of the present invention. FIGS. 25A and 25B are explanatory diagrams showing exemplary bit configurations of signals of instructing to interrupt and resume finalizing which are given to the optical disk apparatus (disk drive apparatus) according to one embodiment of the invention. FIGS. 26A to 26C are explanatory diagrams showing exemplary bit configurations of disk state confirming instruction signals to be given to the optical disk apparatus (disk drive apparatus) according to one embodiment of the invention. FIGS. 27A and 27B are explanatory diagrams showing exemplary bit configurations of reply data from the optical disk apparatus according to instructions given to the optical disk apparatus (disk drive apparatus) according to one embodiment of the invention. FIGS. 28A and 28B are explanatory diagrams showing exemplary bit configurations of data of an interrupting function confirming instruction from a host according to one embodiment of the invention. FIGS. 29A and 29B are explanatory diagrams showing exemplary bit configurations of an interrupted state confirming instruction from the host according to one embodiment of the invention. FIG. 30 is an explanatory diagram showing an exemplary state transition diagram of an optical disk due to finalizing process by the optical disk apparatus (disk drive apparatus) according to one embodiment of the invention. FIGS. 31A to 31C are explanatory diagrams showing one example of recording states of respective areas in the optical disk from an empty state to a finalized state by the optical disk apparatus (disk drive apparatus) according to one embodiment of the invention. FIG. 32 is an explanatory diagram showing one example of recording states of the respective areas in the optical disk when finalizing process by the optical disk apparatus (disk drive apparatus) is interrupted. FIGS. 33A and 33B are explanatory diagram showing another example of recording states of the respective areas in the optical disk (interruption at a good breakpoint) when finalizing process by the optical disk apparatus (disk drive apparatus) is interrupted. FIGS. 34A and 34B are explanatory diagrams showing another example of recording states of the respective areas in the optical disk (in a case where interruption is stopped because of a halfway position) when finalizing process by the optical disk apparatus (disk drive apparatus) is interrupted. FIG. 35 is a flowchart showing an exemplary basic operation of finalizing process by the optical disk apparatus (disk drive apparatus). FIG. 36 is a flowchart showing another exemplary operation when finalizing is interrupted after determining a recording amount or the like of finalizing process by the optical disk apparatus (disk drive apparatus). FIG. 37 is a flowchart showing another exemplary operation when finalizing is interrupted after determining a recording amount or the like of finalizing process by the optical disk apparatus (disk drive apparatus). FIG. 38 is a flowchart showing an exemplary operation of resuming finalizing when a disk is inserted into the optical disk apparatus (disk drive apparatus). FIGS. 39A to 39C are explanatory diagrams showing exemplary GUIs to be displayed for finalizing process by the optical disk apparatus (disk drive apparatus). FIG. 40 is a flowchart when displaying a screen for urging to resume finalizing before a disk in the optical disk apparatus (disk drive apparatus) is ejected. FIGS. 41A and 41B are explanatory diagrams for explaining exemplary screens for urging to resume finalizing before a disk in the optical disk apparatus (disk drive apparatus) is ejected. FIGS. 42A to 42D are explanatory diagrams showing exemplary recording states of the respective areas in the optical disk when finalizing process by the optical disk apparatus (disk drive apparatus) is interrupted. FIGS. 43A to 43D are explanatory diagrams showing exemplary recording states of the respective areas in the optical disk when finalizing process by the optical disk apparatus (disk drive apparatus) is interrupted. FIGS. 44A to 44C are explanatory diagrams showing exemplary recording states of the respective areas in the optical disk when finalizing process by the optical disk apparatus (disk drive apparatus) is interrupted. FIGS. 45A to 45D are explanatory diagrams showing exemplary recording states of the respective areas in the optical disk when finalizing process by the optical disk apparatus (disk drive apparatus) is interrupted.

<Optical Disk Recording/Reproducing System>

FIGS. 1 and 2 are block diagrams of an information recording/reproducing system which is one embodiment of the present invention.

The information recording/reproducing system shown in FIG. 1 includes an optical disk D, an optical disk apparatus 12 and a host unit 14. The optical disk D is a medium on and from which information such as video or user data is recorded and reproduced. The optical disk apparatus 12 records information onto the optical disk D, and reproduces information from the optical disk D. The host unit 14 issues an instruction to the optical disk apparatus 12, and reads necessary information from the optical disk 12 via the optical disk apparatus 12 to reproduce video and display information for a user.

A device 16 such as an optical disk recorder or player has the optical disk apparatus 12 and the host unit 14 incorporated therein as shown in FIG. 1. Although not illustrated, the host unit 14 has a central processing unit (CPU), a random access memory (RAM) used as a work area, and a nonvolatile memory such as an EEPROM (Electrically Erasable and Programmable ROM) or a flash memory which stores and holds configuration parameters, or various data to be retained even when a power supply is tuned off. These memories have stored therein various programs to be executed in response to requests from a user, data required for processes, file systems required for file management, and the like. For example, installed are a UDF bridge file system in a DVD video format, a UDF bridge file system in a DVD video record format, a UDF file system in a next-generation video format, a UDF file system in a next-generation video record format, applications software, and the like.

On the other hand, in a system such as a personal computer, a personal computer serves as the host 14 as shown in FIG. 2. An instruction is issued to the optical disk apparatus 12 by executing applications software such as operating software (OS), writing software, and video playback software.

(Optical Disk Apparatus)

FIG. 3 shows a block diagram of an optical disk apparatus which is one embodiment of the present invention. The optical disk apparatus 12 performs recording/reproducing of information by condensing a laser light emitted from an optical head (pickup head: PUH) actuator 21 onto an information recording layer of the optical disk D. The light reflected from the optical disk D passes through an optical system of the PUH actuator 21 again, and is detected as an electrical signal by a photodetector (PD) 22. The detected electrical signal is amplified by a preamplifier 23, and is outputted to servo circuit 24, an RF signal processing circuit 27, and an address signal processing circuit 28. In the servo circuit 24, servo signals of focusing, tracking, tilting, and the like are generated to be respectively outputted to the PUH actuator (focusing, tracking, and tilting actuators) 22.

A method for reading recorded data and demodulating address signals etc. at that time in the RF signal processing circuit 27 and the address signal processing circuit 28 includes a slicing method and an partial response maximum likelihood (PRML) method. The optical disk apparatus 12 selects an optimum demodulation method in accordance with a size of a condensed beam spot formed by the optical disk D serving as an object for recording/reproducing and the PUH actuator 21. Examples of the slicing method include a method for binarizing the signal after performing linear waveform equalization onto a reproduction signal, and a method for binarizing a reproduction signal after equalizing the signal by a nonlinear equalizer called a limit equalizer which limits low-pass high amplitude components of a reproduction signal to a constant value.

As an PRML method as well, an optimum PR class, for example, PR(1, 2, 2, 21), PR(1, 2, 1), PR(1, 2, 2, 1), PR(3, 4, 4, 3), or the like is selected in response to a frequency characteristic of a reproduction signal. The address signal processing circuit 28 processes a detected signal to read physical address data denoting a recording position on the optical disk D and outputs the data to a controller 29. The controller 29 reads data such as user data at a desired position, or records data at a desired position on the basis of the address data. At that time, the data is converted into a recording waveform control signal suitable for recording onto an optical disk in the recording signal processing circuit 36. Based on the signal, an LD driving circuit (LDD) 25 causes a laser diode (LD) in the optical head 22 to emit light, so that the information is recorded on the optical disk D.

Further, a wavelength of the laser diode in the present embodiment is 405±15 nm. An NA value of an objective lens used for condensing light of the above-described wavelength onto the optical disk D in the optical head 22 is 0.65. Here, assume that the central intensity is “1” as an intensity distribution of incident radiation immediately before the incidence into the objective lens. In this case, the relative intensity in the vicinity of the objective lens (at the boarder position of the opening) is called “RIM Intensity”. Values of RIM Intensity in an HD DVD format are set to be 55 to 70%. An amount of wavefront aberration in the optical head 22 is optically designed so as to be 0.33 λ (0.33 λ or less) at a maximum with respect to a usable light wavelength λ.

<Optical Disk>

Next, the optical disk D which is handled by the information recording apparatus according to the invention will be hereinafter described in detail. FIG. 4 is a schematic diagram of a two-layer optical disk D having two information recording/reproducing layers according to one embodiment of the invention. As shown in FIG. 4, the disk has two information recording layers (hereinafter called layers), and the layouts of the respective information areas are slightly different from each other. The disk of the present invention include two types of a write-once type in which a recording mark is possible only once for one place, and a rewritable type capable of overwriting and erasing a recording mark.

(Formatting of Optical Disk)

FIG. 5 shows physical specifications of a system lead-in or system lead-out area and a rewritable recording area of the optical disk D of the invention. Here, a reference data transfer rate, a light entrance side disk substrate thickness, a track pitch, a shortest mark length, a rotation control method, a recording encoding method are respectively described with respect to the system lead-in or system lead-out area and the rewritable area.

Here, CLV as a rotation control method is an abbreviation for a Constant linear velocity, and means a rotation control method in which a linear velocity is kept constant. ETM (Eight to Twelve modulation) is one of modulation methods, and intended to record signals such that data are converted into channel bits of 12-bit to which redundancy is provided every information bits of 8-bit. Providing redundancy in this way has spectacularly improved the reliability of recording/reproducing of information as compared with a case in which information bits are directly recorded onto the optical disk D.

(Layout of Information Areas)

FIG. 6 shows the layouts of the respective layers of the disk are shown. Here, a layer 0 and a layer 1 are divided into areas so as to have substantially the same configuration. However, a BCA area is arranged as only an area of one of the layers 0 or 1. This is because it is necessary to stabilize reading of information from the BCA area. A BCA mark for use in recording of signals in the BCA area has great interlayer crosstalk. For this reason, when the BCA areas are used in the two layers, interference between respective signals is brought about, which makes it difficult to read information.

The configuration of the areas in the layer is divided into a burst cutting area (BCA), a system lead-in or system lead-out area, a data lead-in or data lead-out area, a data area, and a middle area in order of the inner-peripheral side.

A BCA mark is recorded in advance into the BCA area in accordance with grooves of the substrate, separation of the reflection film, and changes in the recording medium. The BCA mark is a comb mark in which same information is arrayed radially, the mark being modulated in a circumferential direction of the optical disk D. A BCA code is modulated by an RZ modulation method to be recorded. It is necessary for a pulse with a narrow pulse width (=with a low reflectance) to be narrower than the half of a channel clock width of the modulated BCA code. Because the BCA mark has a same shape radially, there is no need to apply tracking thereto, which makes it possible to reproduce information by merely focusing thereon.

Information is recorded with embossed pits in the system lead-in or system lead-out area. The information is management information of the optical disk D such as identification information of a disk and a capacity of a data area. Further, a shortest mark length of the embossed pits in this area is a value double that in the data area. As a result, there is the feature that a normal data area is reproduced by using a PRML method, while in a system lead-in or system lead-out area, not only information can be demodulated even by using a slicing method, but also the reliability of reading of information is improved. Management information fundamental for reading information of the disk, information on copyright management, and the like are recorded in the system lead-in or system lead-out area. For this reason, it is important to improve the reliability of reading of information in the system lead-in or system lead-out area.

Next, grooves serving as races are formed in the recordable management zone in the same way as in the data area. Signals are recorded in this area at the same density as that in the data area. In the area arranged are a trial writing zone, a management zone for grasping a recording state of the data area, a tracking overrun zone for DPD tracking, a guard zone for keeping an interlayer crosstalk amount constant, and the like.

Data such as video data and user data are recorded in the data area.

(Interlayer Crosstalk)

Next, interlayer crosstalk of the optical disk D of the invention will be described. In the two-layer disk according to the invention, as shown in FIG. 7, there is the problem that, when a recording state of signals of a layer (the layer 0) which is not a layer during reproduction (the layer 1 is being reproduced) changes, signals of the layer 1 during reproduction are offset due to crosstalk therefrom. Further, there is the problem that, when signals are recorded on the layer 1, optimum recording power differs depending on whether the layer 0 is recorded or unrecorded. These problems are brought about due to that fact that transmittance and reflectance of the layer 0 in the recording medium change in a recorded state or in an unrecorded state and that it is impossible to increase a thickness of the intermediate layer in order to suppress optical aberration. However, it is extremely difficult to reduce such characteristics physically.

The optical disk D according to the invention has a feature that providing clearances (recording-inhibited areas) as shown in FIG. 8 makes it possible to record/reproduce information without any problem even when such offset of signals is brought about.

FIG. 8 shows a recordable range in the layer 1 in a case where the layer 0 is in a recorded state.

At that time, a recordable range in the layer 1 is a range in which the clearances on the both sides are subtracted from the recorded range in the layer 0. A width of the clearance can be determined by formula (1):

Clearance=Δr+e+Δs (1)

where, Δr is a relative deviation at an actual radial position with respect to the same designed radius of the layer 0 and the layer 1, the deviation occurring due to a manufacturing error etc.; e is an eccentric distance; and As is a radius of a beam spot formed on a layer which is not being reproduced.

(Detailed Layout)

FIG. 9 shows exemplary detailed layouts of the recordable areas of the two-layer optical disk D according to one embodiment of the invention. In the data lead-in or data lead-out area in the layer 0, arranged are a first blank zone Z1, a guard track zone Z2, a drive test zone Z3, a disk test zone Z4, a second blank zone Z5, a recording management data copy zone Z6, a recording management zone Z7, an R physical format information zone Z8, and a reference code zone Z9 from the inside.

A fifth blank zone Z23, a disk test zone Z22, a drive test zone Z21, and a guard track zone Z20 are arranged from the inside in the data lead-in or data lead-out area in the layer 1.

A blank zone is arranged for the purpose of drawing a boundary and ensuring a clearance, and has no data recorded thereon at all. A guard zone is a zone on which dummy data is recorded for measures against overrun of DPD tracking and interlayer crosstalk. A test zone is a zone on which trial writing for optimizing a recording waveform is performed before management information or user information is recorded on the optical disk D. A management zone and a management data copy zone each are a zone on which management information for managing a state of data in recording is recorded onto a data area.

The test zones Z12 and Z13 in the layer 0 are arranged at positions separated by the clearance (the first blank zone Z1) from the system lead-in or system lead-out area in order to avoid crosstalk at the system lead-in or system lead-out area. The test zones Z3 and Z4 and the management zones Z6 and Z7 in the layer 0 are arranged so as to be close to each other with the narrow blank zone Z5 interposed therebetween, and these areas are provided so as to overlap with the guard zone Z20 in the layer 1. The guard zone Z20 in the layer 1 has a width wider by the clearances at the both sides than a total of the widths of the test zones Z3 and Z4 and the widths of the management zones Z6 and Z7 in the layer 0. On the other hand, the test zones Z21 and Z22 in the layer 1 are provided so as to overlap with the guard zone Z2 in the layer 0, and have widths narrower by the clearances at the both sides than the guard zone Z2 in the layer 0.

Here, the optical disk apparatus 12 uniformly records dummy data onto the guard zone Z2, or retains the guard zone Z2 as is unrecorded regardless of recording of user data. In this way, the optical disk apparatus according to the invention has a feature that it is possible to stably write as a trial and to record management information by keeping a constant state such that the opposite layer overlapped with the test zones Z21 and Z22 and the management zones Z6 and Z7 is always in a recorded state or in an unrecorded state.

Next, the structures of the data areas Z10 and Z19 will be described. Data about a user are stored in the data areas Z10 and Z19, and a recording state of data is managed in units of RZone R. In the case where the user data have not reached the ends of the data areas Z10 and Z19 at the time of finalizing, terminators T are formed in the areas. A terminator T is a data area on which dummy data is to be recorded or has been recorded by finalizing process.

Next, a guard zone Z11, a drive test zone Z12, a disk test zone Z13, and a blank zone Z14 are arranged from the inside in the middle area in the layer 0. Similarly, a guard zone Z18, a drive test zone Z17, a disk test zone Z16, and a blank zone Z15 are arranged from the inside in the middle area in the layer 1.

In the same way as those at the system lead-in or system lead-out area, the guard zone Z2 is arranged in the opposite layer overlapped with the test zones Z21 and Z22, and a width of the guard zone Z2 is wider than the widths obtained by adding the widths of the clearances to the both sides of the test zones.

(Structure of Recorded Data)

The information stored and recorded in the optical disk D according to the invention is handled in units called sectors. A sector is composed of user data and header information, and 1 error correction code (ECC) block is composed of 32 or 16 sectors. User data is usually recorded in units of 1 ECC block.

(Content of Format Data in System Lead-In or System Lead-Out Area)

FIG. 10 shows contents of format data in the system lead-in or system lead-out area provided in the layer 0. A book type is an identifier indicating a format and a read-only type, a write-once type, a rewritable type etc. of a disk. A part version is version management information of the format. Information indicating a diameter of the disk is recorded as a disk size. For example, 0000b is recorded in a case of a 12-cm disk, and 0001b is recorded in a case of an 8-cm disk. As a maximum transfer rate, a maximum transfer rate required for normally reproducing data recorded in the disk is recorded as needed.

As a disk structure recorded are the number of layers in the format, information indicating a polarity whether a track goes toward from the inner-peripheral side to the outer-peripheral side, or goes toward the inner-peripheral side in each layer, and information indicating whether the layer is a read-only type, a write-once type, or a rewritable type. The number of the layers used here is not the number of layers possessed by the disk, but the number of layers in the format. Information indicating a density and a track pitch in a direction of tangent line of the disk is recorded as a recording density. Default starting address and ending address of the data area are recorded in the data area structure. Information indicating whether there is a BCA or not is recorded as a BCA identifier. Information indicating a recording speed at which recording onto the disk is possible is recorded as a recordable speed identification data. Further, extension information of a part version is recorded as an extended part version. A maximum linear velocity required for normally reproducing data recorded in the disk is recorded as a maximum playback speed. Types of the disk arranged in the layer 0 and the layer 1 are recorded as layer information.

As mark polarity information recorded is information indicating whether the reflectance of a recording mark is higher or lower than that of an unrecorded portion. When this is 00000000b, the reflectance of the recording mark is higher than that of the unrecorded portion, and when this is 10000000b, the reflectance of the recording mark is lower than that of the unrecorded portion. A standard recording speed is recorded as standard speed information. For example, 6.6 m/s. is recorded in the optical disk D of the embodiment.

Next, a value of rim intensity of the PUH at the time of determining recording waveform data is recorded as rim intensity information. A value of reproducing power required for reproducing the data area is specified as reproducing power information. All actual values of recording speeds to which the disk can respond are recorded as effective recording speed information. The reflectance after recording data onto the data area in the layer 0 is shown as data area reflectance (L).

Here, when the mark polarity information is 00000000b, the reflectance of the marked portion is recorded, and when the mark polarity information is 10000000b, the reflectance of the unmarked (space) portion is recorded. Next, as push-pull signal amplitude information (L) recorded are a value obtained by normalizing a push-pull signal in the layer 0 with a sum signal, and track information indicating a track to/from which recording/reproducing is performed. When the track information is 0b, signals are recorded/reproduced on grooves, while when the track information is 1b, signals are recorded/reproduced on land. Further, as on-track signal information (L) recorded is a value obtained by standardizing a sum signal level of an unrecorded portion in the data area in the layer 0 with a maximum reflection level in the system lead-in or system lead-out area. The data in the layer 1 are respectively recorded in the bytes from the data area reflectance information (L1) to the on-track signal information (L1).

Next, optimum recording waveform data for the layer 0 and the layer 1 recommended by a disk manufacturer are respectively recorded as recording waveform data (L) and (L1). The information include values such as a value of peak power and a value of bottom power of a recording waveform, and values at starting/ending positions of top, middle and final pulses.

FIG. 11 shows the detailed contents in the data area structure. In the data area structure recorded are a starting physical sector number (PSN) of a data area, a maximum physical sector number of a first recordable area, a final physical sector number of a recordable area in the layer 0. Here, the starting physical sector number (PSN) of the data area denotes a starting physical sector number of the data area in the layer 0. The maximum physical sector number of the first recordable area denotes an ending physical sector number of the data area in the layer 1. Further, the final physical sector number of the recordable area in the layer 0 denotes a final physical sector number of the data area in the layer 0.

(Contents of Format Information in Recordable Management Zone)

FIG. 12 shows format information in a recordable management zone. The information is to be recorded in a recordable management zone in process of recording information on the disk by the optical disk apparatus. Here, the same values as those of the format information in a system lead-in or system lead-out area are recorded as information except for data area structure information and starting physical sector number in a border zone.

FIG. 13 shows contents in the data area structure in the format information in the recordable management zone. In the data area structure recorded are a starting physical sector number (PSN) of a data area, an ending physical sector number (PSN) at a first border, and a final physical sector number (PSN) of recorded data in the layer 0. Here, the starting physical sector number (PSN) of the data area denotes a starting physical sector number of the data area in the layer 0. The ending physical sector number (PSN) at the first border denotes an ending physical sector number in the user data area at the first border (which will be described later). Further, as a final physical sector number of recorded data in the layer 0, the final physical sector number in the user data area in the layer 0 is recorded when the first border is provided over the layer 0 and the layer 1. When the first border ends in the layer 0, all the areas are filled with zeros.

FIG. 14 shows the details of starting physical sector numbers in border zones in the format information in the recordable management zone. Here, a border-out starting physical sector number (PSN) at the first border, and a border-in starting physical sector number (PSN) at the following border are recorded. When it is prohibited to prepare the following border, the border-in starting physical sector number is entirely filled with zeros. Accordingly, when this is filled with zeros, it is possible to determine that the disk has been finalized.

(Management Area)

FIG. 15 shows configurations of the recording management data copy zone and the recording management zone. Lead-in recording management data is recorded at the first block in the recording management data copy zone. Next, recording management data are recorded at the following seven blocks in the management zone. Recording management data are sequentially recorded in the recording management zone. Here, lead-in recording management data is information to be recorded when the optical disk apparatus 12 records data first onto the management zone. As shown in FIG. 16, recorded are a recording/reproducing apparatus manufacturer identification number which is an identification number of a manufacturer of the optical disk apparatus 12 for performing recording, a serial number, a model number, and a firmware version number of the apparatus. As a unique disk number, the optical disk apparatus 12 records a unique number for each disk for identifying a disk.

In the recording management data copy zone, a copy of recording management data to be recorded in the recording management zone is recorded, for example, in the case where the management zone is extended or finalized, or the case where a disk is ejected from the optical disk apparatus 12. In the recording management zone, recording management data (RMD) denoting a recording state of the data area are sequentially recorded for each block or as one set of several blocks every time the content of data is changed. Because it is impossible to overwrite data onto a write-once type disk, data are successively written additionally on the following blank blocks every time the important content of the recording management data is updated. Accordingly, the data located most posterior is the most recent recording management data.

FIG. 17 shows a configuration of the recording management data is shown in FIG. 17. The recording management data is composed of 32 fields, and the first filed is an auxiliary field. Fields following the first field are numbered in order, and different information are respectively recorded thereinto.

FIG. 18 shows contents in the field 0 of the recording management data.

Information indicating a record format of data of an RMD is recorded as an RMD record format identifier. A state of a disk in definition, for example, as follows is denoted as disk state information. Assume that, for example, the disk is a write-once type. In this case, “00h” is recorded when the disk is in a blank state, “01h” is recorded when the disk has one border, and is in a finalized state, “02h” is recorded when the disk has user data recorded thereon and is finalized, “03h” is recorded when the disk is in a finalized state, and “11h” is recorded when the disk is in a state during formatting or finalizing. In addition, assume that the disk is a write-once type. In this case, the disk is in a blank state when the disk state information is “00h”, the disk has one border and is in a finalized state when the disk state information is “12h” or “22h”, the disk has user data recorded thereon and is not finalized when the disk state information is “13h” or “23h”, and the disk is in a state during formatting or finalizing when the disk state information is “11h” or “21h”.

Here, “h” shows that numeric characters are expressed by hexadecimal numbers.

FIG. 19 show the details in the data area structure in the recording management data. In the bytes thereof recorded are the same values as those in the data area structure of the format data in the system lead-in or system lead-out area.

FIG. 20 shows contents in the updated data area, in which recorded are values of the data area structure changed at the time of formatting or finalizing. An update identifier is information indicating in what state the data area structure has been changed. 01h is recorded when the data area structure has been changed in response to an instruction to update the data area structure, and 02h is recorded when the data area structure has been changed at the time of finalizing.

FIG. 21 shows contents of the padding state information. Padding information is information indicating whether or not the respective areas in the optical disk D have data recorded thereon, i.e., have been padded. The respective bits in the information are allocated to the respective areas. When “1b” is allocated, the area has been padded, and when “0b” is allocated, the area has not been padded. With respect to the 15 and 16 bits, “00b” indicates that the area is unrecorded, “01b” indicates that the area is in recording, and “10b” indicates that the area has been padded. Here, “b” shows that numeric numbers are expressed by binary numbers. As a final recorded PSN of terminator, a final PSN at a portion having the terminator recorded thereon is stored. Here, when the 15 and 16 bits in the padding state information are 0b, 00000000b is stored as a final recorded PSN of the terminator.

Next, contents of the test zone layout information will be described. In some cases, a position of a test zone is changed due to extension or shifting. For this reason, a starting physical sector number, an ending physical sector number, or a size of the area of the most recent test zone (inner-peripheral test zone, outer-peripheral test zone, extended test zone) at that point in time is recorded in advance in the bytes thereof.

In Field 1 recorded are information on the optical disk apparatus 12 which has performed recording onto the optical disk D and information on the used test zone, and recording waveform data which can be recorded in a unique format by a drive. Those data are put together every 256 bytes, and are respectively named by #1, #2, and . . . . Although not illustrated, the data exists up to #4, and the remaining bytes are spares. Test zone usable address information are prepared independently with respect to respective areas for an inner-peripheral test zone, an outer-peripheral test zone, and an extended test zone, and are further prepared for each of the layers. Here, a final address in a test zone used for itself is recorded, or in an unused case, address information which has been stored is recorded. With the extended test zone being not extended, zeros are recorded entirely as the extended area usable address.

FIG. 22 shows contents in Filed 3. In Field 3, respective border-out final physical sector numbers (PSN) are recorded. When the recording management zone is extended, there are further recorded information indicating whether or not the recording management zone is extended, or a starting physical sector number (PSN) and a size of the extended recording area, and a number of the extended recording area in use. Moreover, when a learning area is extended, a starting physical sector number (PSN) of the extended learning area and a number of total physical sectors, or an ending physical sector number (PSN) are recorded in Field 3.

FIG. 23 shows contents in Fields 4, 5, 6, . . . , and 21. Information for managing a state of the user data area recorded in the data area are recorded in Fields 4, 5, 6, . . . , and 21. The user data area is divided for each RZone R to be managed, and starting physical sector numbers (PSN) of the RZones R and final physical sector numbers (PSN) of the areas which are being recorded currently in the RZones R are recorded in Fields 4, 5, 6, . . . , and 21. Further, it is allowed to prepare up to three open RZones in a state that recording is stopped on the way in the RZone R. There are provided bytes into which the numbers of the RZones in the halfway state are recorded.

<Functions Provided to Optical Disk Apparatus/Host>

Next, functions of the optical disk apparatus 12 and the host 14 according to one embodiment of the invention will be described. FIG. 24 is a diagram for explaining one example (a list of respondable instructions) of commands possessed by the optical disk apparatus (disk drive apparatus).

The optical disk apparatus 12 has a function of making a reply to the host 14 in accordance with a format determined in advance upon receipt of a command shown in the list of FIG. 24 from the host 14. In general, this processing is installed as firmware of the optical disk apparatus 12. On the other hand, the host 14 has also a function of issuing an instruction to the optical disk apparatus 12 to operate the optical disk apparatus 12. In particular, the optical disk apparatus and the host 14 according to the invention each have a function of transmitting/receiving an instruction to finalize a disk, and an instruction to interrupt and resume finalizing as one function of a close instruction; a function of transmitting/receiving information indicating that a disk is in a state of finalizing interruption, a function of transmitting/receiving a padding state of a disk, and a function of transmitting/receiving a list of states in which the drive is capable of interrupting as one function of a disk management information inquiry instruction; and a function of transmitting/receiving a processing time or a throughput until the completion of interruption as one function of a processing result inquiry instruction.

(Interruptive/Resumption Instruction)

FIGS. 25A and 25B show bit configurations of data at the time of issuing instructions to interrupt and resume finalizing to the optical disk apparatus 12 according to one embodiment of the invention. The optical disk apparatus 12 has a function of starting and interrupting finalizing of the optical disk D, and finalizing again the disk on which finalizing has been interrupted upon receipt of the instructions.

The data is composed of 12 bytes, and byte position 0 shows an operation code indicating the contents of an instruction. Here, the operation code indicates close actions.

An immediate bit indicating whether or not it is necessary to immediately make a reply to the instruction is allocated to the first byte at byte position 1. Here, when the instruction is received in a state that the immediate bit is 1b, the optical disk apparatus 12 makes a reply to the instruction immediately after the instruction even if the processing of the instruction is not completed. In a state that the immediate bit is 0b, the optical disk apparatus 12 makes a reply after the processing is entirely completed.

Identifiers indicating the details of the close actions are allocated to the three bytes at byte position 2. Here, when an identifier is “001b”, the optical disk apparatus 12 closes the RZone R as shown in FIG. 25B. When an identifier is “010b”, the optical disk apparatus 12 closes the border. When an identifier is “110b”, the optical disk apparatus 12 finalizes the disk. When an identifier is “111b”, the optical disk apparatus 12 interrupts finalizing onto the disk.

In the case where the optical disk apparatus 12 is not in a state of finalizing operation, and receives an instruction whose identifier is “111b”, i.e., an instruction to interrupt finalizing, the optical disk apparatus 12 makes a reply of “error”.

In the embodiment of the invention, exchanging of instructions between the optical disk 12 and the host 14 is made simple and easy by putting instructions to finalize, interrupt, and resume finalizing together into a same category instruction. However, even when operation codes themselves are separated from each other, it is possible to exchange the instructions and reports.

(Disk State Confirming Instruction)

FIGS. 26A to 26C show bit configurations of data of a disk state confirming instruction. FIG. 26A shows a bit configuration of transmit data at the time of issuing instructions to the optical disk apparatus from the host 14. An operation code indicating an instruction to confirm a state of a disk is allocated to the first byte.

FIG. 26B shows a bit configuration of reply data from the optical disk apparatus in response to the instruction. In the reply, the initial two bytes compose a header, and a byte length of the entire reply is described. Next, a data type, an erasable, a last border state, and a disk state identifier are described at byte position 2 which is the third byte. When the erasable is 1b, it means that the disk is an erasable disk, and when the erasable is 0b, it means that the disk is an inerasable disk. A first RZone number and the number of borders of the disk, a first RZone number at the last border, and a final RZone number at the last border are described in order from byte position 3 on and after. Further, padding state information of the disk is described at byte positions 7 and 8. The final recorded PSN of the terminator is described at byte positions 9 to 11. The bit configuration of the padding state information has the same configuration as that of the padding state information of the recording management data shown in FIG. 21.

FIG. 26C shows a relationship among a state of disk, a state of the last border, and a disk state identifier.

When there is the inquiry of FIG. 26A from the host 14, the optical disk 12 confirms a state of the loaded disk, and makes a reply in accordance with the format of FIG. 26C.

In a case of an empty state in which no user data is recorded in the disk, both of a state of the last border and a disk state identifier are made to be 00b. In a case where user data is being recorded and the disk is recordable additionally, the both areas are made to be 01b. In a case of a disk on which finalizing has been completed, a state of the last border is made to be 11b, and a disk state identifier is made to be 10b. Moreover, in a case where the disk is in a finalizing-interrupted state, a state of the last border and a disk state identifier are made to be 11b and 11b, or 10b and 10b. Depending on the reply, the host 14 is allowed to know whether or not the disk is in a finalizing-interrupted state, and how much or how long it is necessary to record until the completion of finalizing.

(Method for Confirming Interruption Possible Function)

FIGS. 27A and 27B and FIGS. 28A and 28B show bit configurations of data of an instruction to confirm an interrupting function of a drive. The optical disk apparatus 12 has a function of confirming a state of the optical disk D upon receipt of this instruction, and in a case of an apparatus capable of interrupting finalizing, making a reply of an area on which interruption is possible, or a recording amount, a recording time, or the like from a current position of recording in the optical disk up to a position at which interruption is possible.

FIG. 27A shows a bit configuration of transmit data at the time of instructing the optical disk apparatus from the host 14. An operation code indicating an instruction to confirm a state of a disk is allocated to the first byte.

FIG. 27B shows a bit configuration of reply data from the optical disk apparatus in response to the instruction. In the reply, the initial four bytes compose a header, and a byte length of the entire reply is described. Padding state information of the disk is described at byte positions 4 and 5. A last recorded PSN of a terminator is described at byte positions 6 and 7. The bit configuration of the padding state information has the same configuration as that of the padding state information of the recording management data shown in FIG. 21. An interruption possible area identifier is described at byte positions 8 and 9. The respective bits are in the same configuration as that of the padding state information, and show the respective areas in the optical disk D. 1b is described in an area on which finalizing can be interrupted and 0b is described in an area on which finalizing cannot be interrupted. Further, at bit positions 6 and 5, 00b is described when it is impossible to interrupt finalizing, 11b is described when it is possible to terminate finalizing at a point in time when recording of the terminator is completed, and 01b is described when it is impossible to interrupt finalizing in process of recording the terminator.

FIG. 28 shows the bit configurations of another reply data from the optical disk apparatus in response to the instruction of FIG. 27A. In the reply, the initial four bytes compose a header, and a byte length of the entire reply is described. From byte position 4, ECC block sizes until an interruptible place are described two bytes by two bytes in a list.

Although in the drawing, ECC block sizes are defined as units, numbers of physical sectors, times, or ratios may be described. When the optical disk apparatus 12 receives this instruction and has an interrupting function, the optical disk apparatus 12 confirms the state and the recording order of the optical disk D, and counts the number of ECC blocks up to a position where it is possible to interrupt for oneself, and reports a result thereof. The number of ECC blocks until the completion of finalizing is described at the end of the list. In practice, even in a case of a drive without an interrupting function, the number of ECC blocks until the completion of finalizing is described in the list.

In this way, even the optical disk apparatus 12 which does not actually have an interrupting function is capable of making a reply in the same manner as in the apparatus having an interrupting function, which improves the compatibility of the optical disk apparatus 12 from the standpoint of the host 14. In accordance with this instruction, the host 14 is allowed to estimate a recording amount or a time in which it is necessary to record onto the optical disk D at the time of finalizing, or a recording amount to be done until the completion of interruption or a time for recording at the time of executing interruption.

This instruction is expected to be issued in both timings before finalizing and during finalizing. In a case of a timing during finalizing, a currently-padding identifier may be arranged in place of the padding possible identifier in the configuration of FIG. 27B. In this case, only an area currently in recording of the portion of the identifier is 1b, and the other areas are 0b. Moreover, a code indicating an area in recording may be stored in place of an identifier.

(Interrupted State Confirming Instruction)

FIGS. 29A and 29B show bit configuration of an instruction for use in confirming an interrupted state for confirming a time until interruption or a recording capacity of dummy data or the like when the optical disk apparatus 12 is executing an operation of interrupting finalizing.

FIG. 29A shows a bit configuration of transmit data at the time of instructing the optical disk apparatus 12 from the host 14. An operation code indicating an instruction to confirm a state of a disk is allocated to the first byte. FIG. 29B shows a bit configuration of reply data from the optical disk apparatus 12 in response to the instruction.

In the reply, an error code is allocated to the first one byte, and it is described whether the reply is an error or a deferred error. Further, an error identifier is described in four bits at byte position 2, and a further fine identifier is described as an additional error identifier at byte position 12. Identifiers indicating that dummy data for interruption are in recording are described in these areas in process of interrupting. Further, information depending on an error identifier is shown at byte positions 15 to 17. In process of interrupting, described is a percentage of a recording amount from a current recording position until the completion of interruption when a recording amount of dummy data from a point in time when an instruction of interruption is received until the completion of interruption is defined as 100%.

<Finalizing Process>

Next, one example of finalizing process which is one embodiment of the information recording apparatus and the information recording method according to the invention will be described in detail with reference to the drawings.

(State Transition of Optical Disk)

FIG. 30A shows a state transition diagram of the optical disk D due to finalizing process.

As shown in FIG. 30, when the optical disk D is unrecorded, or no user data is recorded therein, the optical disk D is in an empty state Cl. Here, when an instruction to format or write user data is issued from the host 14, the optical disk 12 executes formatting of the optical disk D or recording of user data. As a result, the optical disk D is made to be in a data-in-recording state C2.

When the recording of user data is completed, and an instruction of finalizing is issued from the host 14, the optical disk 12 starts a finalizing operation. At that time, the state of the disk is made to be in a finalizing state C3. When the finalizing is directly terminated without any problem, the disk is made to be in a finalized state C4.

On the other hand, when an instruction to interrupt finalizing is issued during finalizing, and the optical disk apparatus 12 is in a state that finalizing can be interrupted, the processing for interrupting finalizing is executed, and the disk is made to be in a finalizing-interrupted state C5. When an instruction to resume finalizing is issued, the optical disk apparatus 12 resumes finalizing, and the state of the disk is in the finalizing state C3.

Here, in the recording method according to the invention, a recording state of the disk in the finalizing-interrupted state C5 is limited, and information indicating a recording state is stored in the disk. For this reason, in the four states except for the finalizing state among the five states in FIG. 30, it is possible to retain the compatibility of information even when the disk is ejected from the optical disk apparatus 12. Namely, even when the optical disk apparatus 12 for interrupting finalizing and an apparatus for resuming finalizing are different from each other, it is possible to complete the finalizing of the optical disk D.

(Specific Procedure of Finalizing)

FIGS. 31A to 31C show recording states of the respective areas in the optical disk D from an empty state to a finalized state. FIG. 31A shows a state that the optical disk D is unrecorded.

When the optical disk apparatus 12 records user data onto the optical disk D, the optical disk apparatus 12 records some of the first drive test zone Z3 and the second drive test zone Z12 to perform optimization of the recording conditions before the recording, and subsequently records user data.

When there occurs an event in which a certain amount of user data is recorded, or an RZone R is closed, recording management data are recorded in some of the recording management data copy zone Z6 and the recording management zone Z7.

When the recording of user data is changed over the layer 1, recording onto some of the third drive test zone Z17 and the fourth drive test zone Z21 is performed before the recording of user data onto the layer 1, so that recording conditions are optimized. In order to use those drive test zones Z17 and Z21, it is necessary to pad the first and second guard zones Z2 and Z11 in advance.

Accordingly, in many cases, the first and second guard zones Z2 and Z11 are in a state of being padded during recording data, as shown in FIG. 31B. In order for the disk D to be in a finalized state, it is necessary that padding has been performed to the first, second, third, and fourth guard zones Z2, Z11, Z18, and Z20, the first drive test zone Z3, the recording management zone Z7, the reference code zone Z9, the R physical format information zone Z8, and the data areas (the layers 0 and 1) Z10 and Z19. Further, in some cases, it is necessary to fill the recording management data copy zone Z6 and the second drive test zone Z12.

Here, when finalizing is started in the state of FIG. 31B, the optical disk apparatus 12 pads the third guard zone Z18, and fills the unrecorded area of the user area Z19 with a terminator T. Moreover, as shown in FIG. 31C, as areas m to be recorded, the first drive test zone Z3, the recording management data copy zone Z6, the recording management zone Z7, the R physical format information zone Z8, and the reference code zone Z9 are recorded, and then, the fourth guard zone Z20 is recorded, which completes the formatting.

(Method of Interruption)

Next, a method for interrupting finalizing and a state of a disk during interruption will be described. There are three types as interrupting process methods of the optical disk apparatus 12 according to one embodiment of the invention.

A first method is a method for immediately interrupting recording along the way of an area in recording when an instruction of interruption is issued. However, even in that case, recording is interrupted in units of ECC blocks. When interruption is performed in this method, the optical disk apparatus 12 describes a physical sector number PSN at which the interruption has been executed, into the recording management data of the optical disk D. These methods are mainly applied to the terminator T and the drive test zones Z12 and Z17.

A second method is a method for interrupting finalizing after recording onto an area in recording is completed, i.e., after padding is completed when an instruction of interruption is issued. When a reduction in the compatibility between apparatuses can be estimated in the case where recording is interrupted along the way of an area, the recording is terminated at a point in time when the area in recording is completed. At that time, 1b is described into only an area on which recording has been performed into the padding state information of the recording management data. In this way, it is possible to improve the compatibility of the recorded optical disk D. This method is mainly applied to the guard zones Z2, Z11, Z18, and Z20.

A third method is a method for performing interruption after padding to several zones is completed, or for performing finalizing through to completion when an instruction of interruption is issued. This method is used in, for example, a case where, when padding to the drive test zone Z3 in the layer 0 has been completed in the write-once type disk D, or when the rest is less than or equal to a given number of ECC blocks, finalizing is interrupted at a point in time when padding to the respective areas in the layer 0 is entirely performed, or a case where, when disk state information is finalized and padding to the recording management zone is completed, all the remaining areas are padded.

The former is a method for avoiding the following problem. Because there is no drive test zone in the layer 0, it is impossible for another optical disk apparatus 12 to optimize the recording when interruption is performed along the way of the layer 0 and the disk is ejected, which makes it impossible to resume finalizing.

The latter is a method executed because it is impossible to update recording management data, which makes it impossible to perform interruption.

(Interrupted State 1)

First, the first interruptive method will be described. For example, as shown in FIG. 32, when finalizing is executed onto the disk in a state that user data are recorded into the entire layer 0 of the first guard zone Z2, the second guard zone Z11, and the data area Z10, and a part of the layer 1, the optical disk apparatus 12 first starts to record dummy data into this area with the data area Z19 in the layer 1 being as the terminator T.

When the optical disk apparatus 12 receives an instruction to interrupt finalizing during the recording of dummy data, the optical disk apparatus 12 interrupts the recording of dummy data at a border between ECC blocks along the way of the terminator T. Then, recording management data is newly recorded in the recording management zone Z7.

At that time, the disk state information is set to “11b” indicating that the disk D is in a finalizing-interrupted state, “1b” is set in bits indicating the first guard zone Z2 and the second guard zone Z11 for padding state information are in padding states, and “01b” indicating a padding state is set into a bit denoting a state of the terminator T. Moreover, as the final recorded PSN of the terminator T, a final PSN of the recorded dummy data is set. Accordingly, the interruption of finalizing is completed.

(Interrupted State 2)

Next, the second interruptive method will be described. For example, as shown in FIG. 33A, upon receipt of an instruction to interrupt finalizing during recording onto the third guard zone Z18, the optical disk apparatus 12 does not interrupt recording immediately, but records data onto the third guard zone Z18 in currently recording through to completion, and the disk is made to be in the state of FIG. 33B. Then, recording management data is newly recorded into the recording management zone Z7.

At that time, disk state information is set to “11b” indicating that the disk D is in a finalizing-interrupted state, “1b” is set in bits indicating that the first guard zone Z2, the second guard zone Z11, and the third guard zone Z18 for padding state information are in padding states, and “11b” indicating that padding has been completed is set into a bit indicating a state of the terminator T. Accordingly, the interruption of finalizing is completed.

(Interrupted State 3)

Next, the third interruptive method will be described. Assume that, as shown in FIG. 34A, the optical disk apparatus 12 receives an instruction to interrupt finalizing in a state that the optical disk apparatus 12 is recording management data onto the recording management zone Z7, and disk state information is set to “03h” indicating that finalizing has been completed. In this case, the optical disk apparatus 12 does not interrupt the recording immediately, but records data onto all the remaining areas m required for finalizing, which completes the finalizing. As a result, the processing is completed in a state of FIG. 34B. This is the same recording state as in FIG. 31C.

(Procedure of Finalizing Interrupting Process)

Next, the procedure of finalizing interrupting process by the optical disk apparatus 12 will be described in detail hereinafter by use of the flowcharts of FIGS. 35 to 37.

First Interruption Flowchart

In the first interruption flowchart (FIG. 35), basic processes from starting of finalizing up to an interruptive method are specified.

As a procedure of the finalizing interrupting process by the optical disk apparatus 12 according to the invention, it is assumed that, as shown in the flowchart of FIG. 35, the optical disk apparatus 12 receives from the host 14 an instruction to finalize a disk, i.e., an instruction in which an operation code is close, and an identifier is 110b (step S11). When an immediate bit of the instruction data is “1b”, the optical disk apparatus 12 determines whether or not a finalizing operation is immediately possible (step S12). When finalizing is possible in step S12, the optical disk apparatus 12 makes a reply that the processing is normal (step S13). Then, the optical disk apparatus 12 starts the finalizing operation (step S14).

On the other hand, when a finalizing operation is impossible, the optical disk apparatus 12 replies a report of an error indicating that a finalizing operation is impossible to the host 14 (step S24), which leads to abnormal termination (step S25).

The optical disk apparatus 12 sequentially records data onto necessary places including the terminator T, the guard zones Z2, Z11, Z18, and Z20, the drive test zones Z3, Z12, Z17, and Z21, the recording management data copy zone Z6, the recording management zone Z7, and the reference code zone Z9. When there is no interrupting instruction, the optical disk apparatus 12 completes the finalizing directly (steps S26 and S27).

However, when the optical disk apparatus 12 receives an instruction to interrupt finalizing (step S15), and further, an immediate bit of the instruction data is “1b”, the optical disk apparatus 12 determines whether or not it is possible to interrupt finalizing (step S16). When it is possible, the optical disk apparatus 12 makes a reply that the processing is normal (step S17).

On the other hand, even when it is impossible to interrupt finalizing, the optical disk apparatus 12 makes a reply that the processing is normal in the case where the optical disk apparatus 12 has a finalizing interrupting function (step S28). However, in this case, the finalizing is not interrupted, but the finalizing operation is continuously performed (step S29), and then, the finalizing is completed (step S30).

This situation may include, for example, a case after the recording management data has been recorded, or a case in which the optical disk apparatus 12 carries out recording so as to be over the area on which interruption is possible. When the optical disk apparatus 12 has no finalizing interrupting function, the optical disk apparatus 12 replies an error indicating that finalizing is in the process, or an error indicating a warning that the instruction is wrong, to the host 14, and executes the finalizing operation directly through to completion.

The optical disk apparatus 12 having entered the finalizing interruptive operation reports the completion of the process to the host 14 (step S17), and confirms a current recording state (step S18). Here, when the area being currently recorded is an area, such as the terminator T, on which it is possible to immediately stop recording (step S19), the optical disk apparatus 12 terminates the recording at the border of ECC blocks (step S20). Then, recording management data indicating the PSN is recorded on the optical disk D and the finalizing process is interrupted (step S22), and the finalizing process is completed (step S23).

Namely, a position at which the finalizing process is interrupted is recorded as disk state information at byte position 2BP in Filed 0 of recording management data RMD of the disk D. This is recorded in a form as the padding state information in FIG. 21.

Padding information is information indicating whether or not the respective areas on the optical disk D have data recorded thereon, i.e., have been padded. The respective bits in the information are allocated to the respective areas, and “1b” indicates that padding has been performed while “0b” indicates padding has not been performed. Further, with respect to 15 and 16 bits, “00b” indicates that the area is unrecorded, “01b” indicates that the area is in recording, and “10b” indicates that padding has been performed.

On the other hand, when it is impossible to immediately interrupt recording, such as a case where a guard zone is in recording (step S19), the optical disk apparatus 12 carries out the recording onto the area through to completion (step S20). Thereafter, padding state information on the recorded area is set to “1b”, and recording management data is recorded onto the optical disk D, which completes the interruption of finalizing (step S21).

Second Interruption Flowchart

In the second interruption flowchart (FIG. 35), processes for displaying a time required for interruption before interruption of finalizing are specified.

As a procedure of the finalizing interrupting process by the optical disk apparatus 12 according to the invention, it is assumed that, as shown in the flowchart of FIG. 36, the optical disk apparatus 12 receives from the host 14 an instruction to finalize a disk, i.e., an instruction in which an operation code is close and an identifier is 110b (step S41). When an immediate bit of the instruction data is “1b”, the optical disk apparatus 12 determines whether or not a finalizing operation is immediately possible (step S42). When finalizing is possible in step S42, the optical disk apparatus 12 makes a reply that the processing is normal (step S43). Then, the optical disk apparatus 12 starts the finalizing operation (step S44).

On the other hand, when a finalizing operation is impossible, the optical disk apparatus 12 replies a report of an error indicating that a finalizing operation is impossible (step S58), which leads to abnormal termination (step S59).

Here, when the optical disk apparatus 12 receives an instruction to acquire information on a time required for interruption of finalizing from the host 14 (step S45), the optical disk apparatus 12 confirms a current finalizing status (step S46). Then, the optical disk apparatus 12 replies the information on a time required for interruption of finalizing to the host 14 in accordance with the confirmed result (step S47). Thereafter, the optical disk apparatus 12 continues the finalizing operation (step S48).

Note that, in the host device, as will be described later in FIG. 39C, a remaining time of a time required for interruption of finalizing based on the time required for interruption of finalizing is displayed, such as 2:31 and the remaining processing 20% on a screen.

Next, the optical disk apparatus 12 sequentially carries out recording onto necessary places including the terminator T, the guard zones Z2, Z11, Z18, and Z20, the drive test zones Z3, Z12, Z17, and Z21, the recording management data copy zone Z6, the recording management zone Z7, and the reference code zone Z9. When there is no interrupting instruction (step S49), the optical disk apparatus 12 completes the finalizing directly (steps S60 and S61).

However, when the optical disk apparatus 12 receives an instruction to interrupt finalizing, and moreover, an immediate bit of the instruction data is “1b” (step S49), the optical disk apparatus 12 determines whether or not it is possible to interrupt finalizing (step S50). When it is possible, the optical disk apparatus 12 makes a reply that the processing is normal (step S51).

On the other hand, when it is impossible to interrupt finalizing, the optical disk apparatus 12 makes a reply that the processing is normal in the case where the optical disk apparatus 12 has a finalizing interrupting function (step S62). However, in this case, the finalizing is not interrupted, but the finalizing operation is continuously performed (step S63), and then, the finalizing is completed (step S64). 208 This situation may include, for example, a case after the recording management data has been recorded, or a case in which the optical disk apparatus 12 carries out recording so as to be over the area in which interruption is possible. When the optical disk apparatus 12 has no finalizing interrupting function, the optical disk apparatus 12 replies an error indicating that finalizing is in the process, or an error indicating a warning that the instruction is wrong, to the host 14, and executes the finalizing operation directly through to completion.

The optical disk apparatus 12 having entered the finalizing interruptive operation reports the completion of the process to the host 14 (step S51), and confirms a current recording state (step S52). Here, when the area being currently recorded is an area, such as the terminator T, on which it is possible to immediately stop recording (step S53), the optical disk apparatus 12 terminates the recording at the border of ECC blocks (step S54). Then, the recording management data indicating the PSN is recorded on the optical disk D, and the finalizing is interrupted (step S56), and the finalizing process is completed (step S57).

On the other hand, when it is impossible to immediately interrupt recording, such as a case in which a guard zone is in recording (step S53), the optical disk apparatus 12 carries out recording onto the area through to completion (step S54). Thereafter, padding state information on the recorded area is set to “1b”, and recording management data is recorded onto the optical disk D, which completes the interruption of finalizing (step S55).

In the second flowchart, information on a time required for interruption of finalizing is acquired along the way, and is used, which makes it possible for a user to know how long it takes for the finalizing interrupting process.

Third Interruption Flowchart

In the third interruption flowchart (FIG. 37), processes for displaying a time required for interruption after interruption of finalizing are further specified.

As a procedure of the finalizing interrupting process by the optical disk apparatus 12 according to the invention, it is assumed that, as shown in the flowchart of FIG. 37, the optical disk apparatus 12 receives from the host 14 an instruction to finalize a disk, i.e., an instruction in which an operation code is close, and an identifier is 110b (step S71). When an immediate bit of the instruction data is “1b”, the optical disk apparatus 12 determines whether or not a finalizing operation is immediately possible (step S72). When finalizing is possible in step S72, the optical disk apparatus 12 makes a reply that the processing is normal (step S73). Then, the optical disk apparatus 12 starts the finalizing operation (step S74).

On the other hand, when a finalizing operation is not possible, the optical disk apparatus 12 replies a report of an error indicating that a finalizing operation is impossible (step S74), and the processing is abnormal termination (step S75).

The optical disk apparatus 12 sequentially carries out recording onto necessary places including the terminator T, the guard zones Z2, Z11, Z18, and Z20, the drive test zones Z3, Z12, Z17, and Z21, the recording management data copy zone Z6, the recording management zone Z7, and the reference code zone Z9. When there is no interrupting instruction, the optical disk apparatus 12 completes finalizing directly (steps S88 and S89).

However, when the optical disk apparatus 12 receives an instruction to interrupt finalizing (step S75), and moreover, an immediate bit of the instruction data is “1b”, the optical disk apparatus 12 determines whether or not it is possible to interrupt finalizing (step S76). When it is possible, the optical disk apparatus 12 makes a reply that the processing is normal (step S77).

On the other hand, when it is impossible to interrupt finalizing, the optical disk apparatus 12 makes a reply that the processing is normal in the case where the optical disk apparatus 12 has a finalizing interrupting function (step S90). However, in this case, the finalizing is not interrupted, but the finalizing operation is continuously performed (step S91), and then, the finalizing is completed (step S92).

This situation may include, for example, a case after the recording management data has been recorded, or a case in which the optical disk apparatus 12 carries out recording so as to be over the area in which interruption is possible. When the optical disk apparatus 12 has no finalizing interrupting function, the optical disk apparatus 12 replies an error indicating that finalizing is in the process, or an error indicating a warning that the instruction is wrong to the host 14, and executes the finalizing operation directly through to completion.

The optical disk apparatus 12 having entered the finalizing interruptive operation reports the completion of the process to the host 14 (step S77), and confirms a current recording state (step S78).

The optical disk apparatus 12 confirms a current state of the disk when the interrupting process is started, and sets a time required for interruption in a memory (step S79). Here, when an instruction to confirm an interrupted state as shown in FIG. 29 is issued from the host 14 (step S80), the optical disk apparatus 12 reports a remaining recording amount until the interruption to the host 14 (step S81).

Note that, in the host 14, as will be described later in FIG. 39C, a remaining time of a time required for interruption of finalizing based on the time required for interruption of finalizing is displayed, such as 2:31 and the remaining processing 20% on a screen.

These processes of padding are continued until recording onto predetermined areas are completed (step S83). Then, at a point in time when the finalizing process is completed, the recording management data is updated (step S84), and interruption of the finalizing process is completed (step S85).

(Writing Software GUI: Interruption)

Writing software and functions of a recorder according to one embodiment of the present invention will be described. The writing software according to the invention is installed as, for example, PC software in a PC 18 in FIG. 1, and has a graphical user interface (GUI) to function as the host 14 of the optical disk apparatus 12. When an order is received from a user through the GUI or a command, the writing software issues an instruction to the optical disk apparatus 12 in response to the order. Further, the recorder has the optical disk apparatus 12 and the host 14 built-in, and the host 14 has the same function as that of the writing software, i.e., a function of receiving an order from a user and issuing an instruction to the optical disk apparatus 12.

Here, the host 14 according to the invention has a function of receiving an order to interrupt finalizing from a user, for example, a function allocated to a button on a GUI as shown in FIG. 39A, and to a shortcut key of a keyboard or the like.

Further, the host 14 has a function of issuing an interrupting instruction to the optical disk apparatus 12 in response to an order to interrupt finalizing from a user, and a function of instructing to confirm an interrupting function and to confirm an interrupted state of the optical disk apparatus 12 during interruption or immediately before interruption.

Here, the GUI shown in FIG. 39A is a screen when the optical disk apparatus 12 performs usual recording processing, and shows that finalizing process is started by selecting the button of “Close disk”, and it takes a required time, for example, of 72 minutes 15 seconds at that time.

Further, the GUI shown in FIG. 39B is a screen when the optical disk apparatus 12 is executing finalizing process, and the finalizing interrupting process is started by selecting the button of “Interruption”. The screen shows that about 50% of the current finalizing process has been performed and a time required for remaining finalizing processing is 36 minutes 7 seconds. However, an elapsed time and an elapsed percentage are preferably displayed.

Further, the GUI shown in FIG. 39C is a screen when the optical disk apparatus 12 is performing an interrupting process of finalizing process. The screen shows that the button of “Interruption” is selected, about 20% of the finalizing interrupting process has been performed, and it takes a required time of 2 minutes 31 seconds. In the same way, an elapsed time and an elapsed percentage are preferably displayed.

Here, when a reply from the optical disk apparatus 12 is one as shown in FIG. 29, the writing software displays that value directly as an indicator. In the case of the form in FIG. 27, the writing software has a function of displaying already-recorded areas and remaining areas on a GUI, and of displaying by calculating a number of remaining ECC blocks on the basis of sizes of the respective areas in the optical disk D, or by calculating a remaining time on the basis of a recording speed. Further, this applies to the case in which the reply is in the form as shown in FIG. 28 as well.

(Processing of Resuming Finalizing Optical Disk in Finalizing Interrupting Process)

Next, with reference to the flowchart in FIG. 38, description will be given to the processes of the host 14 and the optical disk apparatus 12 when the optical disk D on which the finalizing interrupting process has been already performed is inserted into the optical disk apparatus 12.

The host 14 confirms a status of the optical disk apparatus 12 periodically in accordance with a structural state inquiry instruction or the like (step S101). When the optical disk D is inserted, the host 14 acquires a type thereof or information of a recording state (step S102). Then, the host 14 carries out a report on type confirmation information of the disk/apparatus (step S103), a receipt of an instruction to confirm a state of the disk (step S104), and a report on disk state confirmation information (step S105).

Then, when the inserted optical disk D is a write-once type disk, and in a finalizing-interrupted state, it is impossible to additionally record user data. For this reason, the host 14 performs processes of enabling a writing function of the host, of displaying that it is impossible to write on a GUI, or the like.

Moreover, when the inserted optical disk D is in a finalizing-interrupted state depending on a situation (step S106), a display giving a suggestion to resume finalizing as in FIG. 41B is performed in order to improve the compatibility. Further, if the disk is still in a finalizing-interrupted state when a user ejects a disk after processes such as data readout are completed, the host 14 outputs a display for urging to resume finalizing before the disk is ejected, as shown in FIG. 41A. Note that, when the inserted optical disk D is not in a finalizing-interrupted state, the routine proceeds to usual recording/reproducing operations (step S107).

When the inserted optical disk D is in a finalizing-interrupted state, the host 14 can display how long a time required for finalizing is by utilizing, for example, a reply to an instruction of FIG. 27. Here, when the user selects resumption of finalizing (step S108), the completion of the process is reported (step S109). The host 14 issues an instruction of finalizing to the optical disk apparatus 12, and the optical disk apparatus 12 resumes finalizing of the optical disk D upon receipt of an instruction to resume finalizing (step S110).

In other words, the padding state information recorded as disk state information at byte position 2BP in Field 0 of the recording management data RMD of the optical disk D is read out, and areas to be finalized are determined on the basis of the information to perform padding.

At that time, it is preferable to display a GUI as shown in FIG. 39B on a display unit (not shown) or the like of the recorder.

Further, the padding information is information indicating whether or not the respective areas in the optical disk D have data recorded thereon, i.e., have been padded. The respective bits in the information are allocated to the respective areas, and “1b” indicates that the area has been padded while “0b” indicates that the area has not been padded. With respect to 15 and 16 bits, “00b” indicates that the area is unrecorded, “01b” indicates that the area is in recording, and “10b” indicates that the area has been padded.

In this way, the host 14 (or the optical disk apparatus) according to the invention has a function of warning a user that the disk is an optical disk in a finalizing-interrupted state when the optical disk D is inserted and ejected, and of urging the user to resume and perform finalizing process again.

As another embodiment, a controller 29 of the information recording apparatus preferably functions as follows. That is, when a new recording medium D is given, management information RMD on the recording medium are automatically read out by a head unit, and when it is detected that finalizing process on the recording medium is interrupted on the basis of the management information RMD, the controller 29 automatically resumes the finalizing process onto the recording medium even without any instructive signal.

(Flowchart of Software Side Interrupting Process)

Next, a software side interrupting process will be described in detail by use of the flowchart of FIG. 39.

Namely, it is preferable that the operations of the finalizing process described above are provided as, not only functions of the optical disk apparatus 12 as described above, but also functions of the host 14 connected to the optical disk apparatus 12. It is also preferable that the operations of the finalizing process are provided as functions of a computer program for use in the host 14.

As shown in FIG. 39, upon receipt of a request of finalizing from a user (step S121), the host 14 issues an instruction of finalizing to the optical disk apparatus 12 (step S122). Here, when the host 14 issues an instruction whose immediate is 1b, the host 14 receives a report of the completion of the process if the optical disk apparatus 12 normally operates (step S123).

Subsequently, the host 14 transmits an instruction to confirm a state of the apparatus periodically to the optical disk apparatus 12 (step S124). A status of the finalizing process is replied in response to the instruction from the optical disk apparatus 12 (step S125).

On the other hand, the host 14 updates the display on the GUI and the indicator display of the process in accordance with the reply (step S126). When there is no request to interrupt finalizing from the user (step S127), the finalizing is directly completed (step S128). When the finalizing is completed, the host 14 displays the completion of finalizing (step S129).

On the other hand, when there is a request to interrupt finalizing (step S127), the host 14 transmits an instruction to interrupt finalizing to the optical disk apparatus 12 (step S130). When the host 14 issues an instruction whose immediate is 1b, the host 14 receives a report of the completion of the process if the optical disk apparatus 12 normally operates (step S131).

Then, the host 14 transmits an instruction to confirm a state of the apparatus periodically to the optical disk apparatus 12 (step S132). This instruction has a bit configuration as shown in, for example, FIG. 29. Subsequently, the host 14 receives a reply from the optical disk apparatus 12 (step S133), and updates the display on the GUI and the indicator display of the process in accordance with the reply (step S134). This makes it possible for the user to confirm a status until the interruption.

When it is confirmed that the finalizing interrupting process is completed in accordance with the reply from the optical disk apparatus 12 (step S135), the host 14 changes the GUI to complete the interruption of finalizing (step S136).

(Interruption of Finalizing When Extended Guard Zones are Formed)

Next, an example of an interrupted state other than the three interrupted states in FIGS. 32 to 34 will be described.

An interrupted state (4) in the case where a reserved zone (A) is provided and a third extended guard zone (B) corresponding thereto is provided, will be described with reference to FIG. 42.

FIG. 42A shows a state in which the RZone R is reserved by the reserved zone (A). Although the portion corresponding to the (A) in the drawing is originally a data area, the area becomes an RZone R reserved by the processing of reserving an RZone R.

The portion corresponding to the (B) in the drawing is an area substantially overlapping with the portion of the (A), and an area extended to the outer-peripheral side by a length of a clearance. This is an area called the third extended guard zone.

FIG. 42B shows a state in which user data is in process of recording. The user data are being recorded onto a part of the reserved RZone R and a part of the remaining user data. In order to finalize the disk, it is necessary to pad not only the recording area for finalizing the disk on which an RZone R has not been reserved, but also the reserved RZone R and the second extended guard zone (B).

When there is an instruction of finalizing, the optical disk apparatus 12 sequentially executes recording such as recording of the terminator T, padding of an unrecorded area of the reserved RZone R, and recording of the second extended guard zone (B).

As shown in FIG. 42C, when an instruction to interrupt finalizing is received in process of recording along the way of the reserved RZone R, the optical disk apparatus 12 can immediately interrupt the recording, and complete the interruption by changing the final recorded PSN of an RZone R number n in the recording management data. On the other hand, the optical disk apparatus 12 can perform interruption at that point in time when recording onto the RZone R is performed until the end. In this case, it takes much processing time, but the compatibility is improved.

Assume that, as shown in FIG. 42D, an instruction to interrupt finalizing is received in the process of recording onto the third extended guard zone. In this case, like the terminator T, the optical disk apparatus 12 immediately interrupts the recording and updates the final recorded PSN of the terminator T to interrupt the finalizing. In this way, the third extended guard zone (B) can be handled as a part of the terminator T.

(Interruption of Finalizing When Middle Area is Extended)

Next, with reference to FIGS. 43A and 43B, description will be given to an interrupted state (5) when a second extended guard zone (C), a first extended guard zone (F), a first extended drive test zone (D), an extended blank zone (G), and an extended blank zone (E) are formed.

In a case of FIG. 43A, it is necessary to pad at least the first extended guard zone (F) and the second extended guard zone (C) at the time of finalizing, as shown in FIG. 43B.

For example, when an instruction of interruption is received in the process of recording onto the first extended guard zone, the recording onto the first extended guard zone is performed until the end, and the padding state information is updated, which leads to the completion of the interruption. Here, there are no bits allocated for the first extended guard zone to the padding state information. However, when the first and second extended guard zones are prepared, the information at bit position 7 denotes a state of, not the third guard zone, but the first extended guard zone. Accordingly, when there is the first extended guard zone, 0b is stored when the first extended guard zone is unrecorded while 1b is stored when padding has been completed, regardless of a recording state of the third guard zone.

Next, an interrupted state (5) when the second extended guard zone (C), the first extended guard zone (F), and the extended blank zone (G) are formed will be described with reference to FIGS. 43C and 43D.

In a case of FIG. 43C, it is necessary to, as shown in FIG. 43D, perform recording onto the second extended guard zone (C) and the first extended guard zone (F) until the end at the time of finalizing, thereby obtaining the state of FIG. 42B or 42D.

For example, when an instruction of interruption is received in the process of recording onto the first extended guard zone, the recording onto the first extended guard zone is performed until the end, and the padding state information is updated, which leads to the interruption is completed.

(Interruption of Finalizing When Finalizing is Performed with Final Position of Data Recording Along the Way of Layer 0)

Next, a finalizing-interrupted state (6) and an interrupted state (6) when finalizing is performed with the final position of data recording along the way of layer 0 will be described with reference to FIGS. 44 and 45.

First, an interrupted state (7) shown in FIG. 44 will be described.

FIG. 44A shows a case in which finalizing is performed with user data recorded until part of the way of the data area Z10 in the layer 0.

When there is an instruction of finalizing with user data being still along the way of the layer 0 as shown in FIG. 44A, the optical disk apparatus 12 applies a predetermined amount of terminator onto the layer 0, and further makes the data area in the layer 1 overlapping therewith be terminator T. There is no need to record data on the data area which cannot be terminator T in the layer 0, as a blank zone. Here, when an instruction to interrupt finalizing is received in the process of recording the terminator T, the recording is interrupted in units of ECC blocks and the interruption of finalizing is completed by updating the recording management data, in the same way as the status in FIG. 32.

Next, an interrupted state (7) shown in FIG. 45 will be described.

When the recording has been made to progress up to the outer periphery of the data area Z10 in the layer 0 to a significant extent as shown in FIG. 45A, it is necessary not only to make the remaining area in the layer 0 be terminator T, but also to pad the second guard zone Z11 for finalizing, as shown in FIGS. 45B and 45C.

In this case, when a command to interrupt finalizing is received in the process of recording onto the second guard zone, the optical disk apparatus 12 needs to pad the second guard zone Z11 until the end as shown in FIG. 45D, and the interruption is completed by updating the recording management data.

<Other Functions of Host>

In the above descriptions, the procedure in which the host 14 interrupts or resumes finalizing in response to an instruction from the user has been described. However, as another embodiment, in an apparatus which needs management of electricity such as a notebook personal computer or a camcorder, the host 14 monitors electricity of the apparatus, and the host 14 has a function of issuing an instruction to interrupt finalizing to the optical disk apparatus 12 to thereby interrupt finalizing when the electricity is less than a given value. Even in this case, there is the advantage that the method for interrupting finalizing according to the invention is available for a drive which is not a drive having interrupted resumption of finalizing onto an interrupted disk.

Note that the present invention is not limited to the above-described embodiments as is, and at the stage of implementing the invention, the components may be modified and implemented within a range which does not deviate from the gist of the present invention. Further, various inventions can be formed by appropriately combining of the plurality of components disclosed in the above-described embodiments. For example, several components may be eliminated from all the components shown in the embodiments. Moreover, components covering different embodiments may be appropriately combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording apparatus comprising:
a head unit which records data and detects a reflected light by irradiating a laser light onto a recording medium having a recorded area, an unrecorded area, and a management area; and
a control unit which controls the head unit so that pattern data is recorded in the unrecorded area of the recording medium to perform finalizing process onto the recording medium, the finalizing process is interrupted in accordance with an interrupting instruction, and an interrupted position of the finalizing process is recorded in management information of the recording medium.

2. The information recording apparatus according to claim 1, wherein the control unit records the interrupted position of the finalizing process as disk state information at byte position 2 in Field 0 of recording management data of the recording medium.

3. The information recording apparatus according to claim 1, wherein, upon receipt of the interrupting instruction while finalizing process onto a predetermined area on the recording medium is performed, the control unit continues the finalizing process until the finalizing process onto the predetermined area is completed, and when the finalizing process onto the predetermined area is completed, the control unit interrupts the finalizing process for the recording medium, and records an interrupted position of the finalizing process in the management information of the recording medium.

4. The information recording apparatus according to claim 1, wherein, upon receipt of the interrupting instruction when an area on which finalizing process has not been performed is only a predetermined area, the control unit continues the finalizing process onto the predetermined area through to completion without interrupting the finalizing process.

5. The information recording apparatus according to claim 1, wherein the control unit confirms a state of the recording medium on the basis of information received from the head unit, and outputs a recording amount required up to interruption or completion of the finalizing process to an external apparatus.

6. The information recording apparatus according to claim 1, wherein, upon receipt of an instruction of resumption, the control unit reads out the management information in accordance with the instruction of resumption, and resumes the finalizing process on the basis of the management information.

7. The information recording apparatus according to claim 1, wherein, when a new recording medium is provided, the control unit reads out management information of the recording medium by the head unit, and when it is detected that finalizing process onto the recording medium is interrupted on the basis of the management information, the control unit resumes the finalizing process onto the recording medium even without any instructive signal.

8. The information recording apparatus according to claim 1, wherein, when a new recording medium is provided, the control unit reads out management information of the recording medium by the head unit; when it is detected that finalizing process onto the recording medium is interrupted on the basis of the management information, the control unit reports that the finalizing process onto the recording medium is interrupted, and displays a screen for urging to resume the finalizing process; and upon receipt of an instruction of resumption, the control unit resumes the finalizing process onto the recording medium.

9. An information recording method comprising:
performing finalizing process to a recording medium having a recorded area, an unrecorded area, and a management area by recording pattern data into the unrecorded area;
interrupting the finalizing process in accordance with an interrupting instruction; and
recording an interrupted position of the finalizing process in management information of the recording medium.

10. The information recording method according to claim 9, further comprising:
recording the interrupted position of the finalizing process as disk state information at byte position 2 in Field 0 of recording management data of the recording medium.

11. The information recording method according to claim 9, further comprising:
upon receipt of the interrupting instruction while finalizing process onto a predetermined area on the recording medium is performed, continuing the finalizing process until the finalizing process onto the predetermined area is completed; and
when the finalizing process onto the predetermined area is completed, interrupting the finalizing process for the recording medium, and recording an interrupted position of the finalizing process in the management information of the recording medium.

12. The information recording method according to claim 9, further comprising:
upon receipt of the interrupting instruction when an area on which finalizing process has not been performed is only a predetermined area, continuing the finalizing process onto the predetermined area through to completion without interrupting the finalizing process.

13. The information recording method according to claim 9, further comprising:
confirming a state of the recording medium on the basis of information received from the head unit, and outputting a recording amount required up to interruption or completion of the finalizing process to an external apparatus.

14. The information recording method according to claim 9, further comprising:
upon receipt of an instruction of resumption, reading out the management information in accordance the instruction of resumption, and resuming the finalizing process on the basis of the management information.

15. The information recording method according to claim 9, further comprising:
when a new recording medium is provided, reading out management information of the recording medium, and when it is detected that finalizing process onto the recording medium is interrupted on the basis of the management information, resuming the finalizing process onto the recording medium even without any instructive signal.

16. The information recording method according to claim 9, further comprising:
when a new recording medium is provided, reading out management information of the recording medium;
when it is detected that finalizing process onto the recording medium is interrupted on the basis of the management information, reporting that the finalizing process onto the recording medium is interrupted, and displaying a screen for urging to resume the finalizing process; and
upon receipt of an instruction of resumption, resuming the finalizing process onto the recording medium.

17. An information processing apparatus comprising:
a function of supplying an instructive signal for causing an information recording apparatus which handles a recording medium having a recorded area, an unrecorded area, and a management area to record pattern data into the unrecorded area and perform finalizing process;
a function of supplying an instructive signal for instructing a process of interrupting the finalizing process; and
a function of outputting a display signal for displaying a processing status of the process of interrupting the finalizing process.

18. An information processing method comprising:
supplying a driving signal for causing an information recording apparatus which handles a recording medium having a recorded area, an unrecorded area, and a management area to record pattern data into the unrecorded area and perform finalizing process;
supplying a driving signal for a process of interrupting the finalizing process to the information recording apparatus in accordance with an interrupting instruction; and
when an interrupted position of the finalizing process is detected, supplying a driving signal for recording positional information thereof in management information of the recording medium, to the information recording apparatus.

19. The information processing method according to claim 18, wherein, during the finalizing process, a display signal for an operation screen for receiving an instruction of interrupting the finalizing process is supplied to a display device.

20. The information processing method according to claim 18, wherein, when the instruction of interrupting the finalizing process is received, a processing status until interruption process is completed is displayed on the screen.

21. The information processing method according to claim 18, further comprising:
when it is detected that a new recording medium is provided to the information recording apparatus, causing the information recording apparatus to read out management information of the recording medium;
when it is detected that finalizing process onto the recording medium is interrupted on the basis of the management information, reporting that the finalizing process onto the recording medium is interrupted, and displaying a screen for urging to resume the finalizing process; and
when an instruction of resumption is received, instructing the information recording apparatus to resume the finalizing process onto the recording medium.
